(19) United States
(12) Patent Application Publication
(10) Pub. No.: US 2009/0228244 A1
(43) Pub. Date: Sep. 10, 2009

(54) System and method for simulating motion of a multibody system

(76) Inventors: Joris Naudet, Schilde (BE); Dirk Lefeber, Liezele (BE)

Correspondence Address: BACON & THOMAS, PLLC, 625 SLATERS LANE, FOURTH FLOOR, ALEXANDRIA, VA, 22314-1176, US

(21) Appl. No.: 11/659,482

(22) PCT Filed: Jun. 15, 2005
(86) PCT No.: PCT/BE05/00097

§ 371 Date: Feb. 6, 2007

(30) Foreign Application Priority Data
Aug. 6, 2004 (EP) 04447184.5

(51) Int. Cl. G06F 17/11; G06F 17/50; G06G 7/48

(52) U.S. Cl. 703/2; 703/7

(57) ABSTRACT

The present invention relates to a method and system for describing the motion of a closed-loop multibody mechanism. In this case, equations of motion need to be obtained for constrained multibody systems. The invention is based on a forward dynamics formulation resulting in a recursive Hamiltonian formulation for closed-loop systems using generalised co-ordinates and conjugated canonical momenta. The method allows to limit the number of arithmetical operations necessary to obtain the equations of motion with a good evolution of the constraints violation errors. Calculations can be performed based on constrained articulated momentum vectors.

### TECHNICAL FIELD OF THE INVENTION

The present invention relates to systems and methods for visualising, simulating or predicting motion of mechanical systems comprising multiple bodies. More specifically, the present invention relates to systems and methods for efficiently describing motion of a constrained mechanical system comprising multiple bodies and systems and methods for studying, visualising, simulating or predicting the forward dynamics of a constrained mechanical system comprising multiple bodies. The methods may be used for design purposes or for verifying design performance. Further the present invention relates to controllers for control of multibody systems that use methods for simulating or predicting motion, e.g. a controller for controlling the movement of a robot or a flight or transport vehicle simulator. The control may be made at a distance, e.g. for the control of robotic vehicles for planetary exploration controlled from earth, i.e. with an unacceptable transmission delay. It also relates to software implementing methods for simulating or predicting such motion. It also relates to games which require simulation or prediction of multibody movements for realistic display purposes.

### BACKGROUND OF THE INVENTION

During the last decades, significant effort has been put in the improvement of simulation methods for mechanical systems comprising multiple bodies, also called multibody systems. These efforts have been required by the ever increasing complexity of investigated structures and the need for faster simulations to reduce time-to-market or enable real-time computations. Simulation of the motion of mechanical multibody systems has a wide variety of applications such as virtual prototyping, virtual reality and computer animation. In virtual prototyping, computer models and simulations are used to check and study the behaviour of mechanical systems such as e.g. cars or a landing gear of a spacecraft without the need to build prototypes. The latter allows a significant reduction both in temporal and financial costs. For virtual reality, the simulations of the motion of mechanical multibody systems need to be very efficient as they need to be in real-time. Mechanical animations are used in a wide variety of applications, e.g. in animation movies and computer games. In all these applications a computational high efficiency is indispensable.

The usability of algorithms typically is determined by two important factors: a first factor is the ease of establishment of the equations of motion, a second factor is the ease of numerical integration of these equations. From the numerous ways to treat the equations of motion, the recursive formulations have proven to be very efficient for large numbers of bodies, as shown in e.g. Robot Dynamics Algorithms by Featherstone (Kluwer Academic Publishers 1987). Most of the well-known methods and systems for describing motion of a mechanical system comprising multiple bodies are based on Newton-Euler equations, the Lagrangian equations or the principle of virtual work or virtual power, i.e. expressing that reaction forces do not deliver any power under a virtual motion. In all these cases, second order differential equations are obtained and the algorithms come down to calculating and integrating accelerations.

The set of co-ordinates used to describe the system also strongly influences the usability of the algorithms, as the type and number of co-ordinates has strong repercussions on the numerical integration of the equations of motion. Expressing the equations of motion in a minimal set of co-ordinates results in less differential equations, which are however more coupled and usually exhibit stronger non-linearities, compared to non-minimal formulations. The advantage of using a minimal set of co-ordinates is that no constraint equations are required and that only a set of ordinary differential equations (ODE's) must be solved. Non-minimal formulations on the other hand, result in a differential algebraic equation system (DAE), but are in general much easier to establish.

Besides manipulating the number of co-ordinates, also the type of co-ordinates used to describe the system can be chosen specifically. Acceleration based formulations require starting values for the generalised co-ordinates and the velocities. In that sense, one can also think of these equations as first order differential equations in the generalised co-ordinates and the velocities. An alternative formulation is obtained if Hamilton's equations are used, which are expressed in terms of the generalised co-ordinates and their conjugated canonical momenta. The latter equations, also referred to as Hamiltonian equations, behave better during numerical integration, resulting in more accuracy and stability. Nevertheless, the Hamiltonian formulation is not often used in the description of multibody dynamics. The reason probably is that the construction of Hamilton's equations is computationally intensive and cannot compete with the recursive acceleration based algorithms, even with the advantageous behaviour during the numerical integration. Nevertheless, the use of Hamiltonian equations in multibody systems dynamics has led to very positive results, as for example described by Lankarani et al. in Advances in Design Automation 1, (1988) 417-423 and by Bayo et al. in Nonlinear Dynamics 5, (1994) 209-231. An additional step to promote the use of conjugated canonical momenta was taken by introducing a new recursive method to establish Hamilton's equations for open-loop rigid multibody systems, as described by Naudet et al. in Multibody Dynamics 2003 IDMEC/IST Lisbon, Jul. 14, 2003. The latter method describes an Hamiltonian O(n) equivalent for the acceleration based methods which exceeds the acceleration based algorithms in performance at the level of number of required arithmetical operations. Another example of a method for describing the forward dynamics of an open-loop multibody mechanism is described by Naudet et al. in Multibody System Dynamics 10 (2003) pages 45-59.

The problem of describing the dynamics of a constraint multibody system, as is e.g. the case with closed-loop systems, is even more labour-intensive and tedious. Applying the above described methods of the prior art on closed-loop systems typically results in inefficient methods. If e.g. the calculations are based on the use of the Jacobian of the constraint equations, which is a legal way of tackling the problem, huge obstacles are introduced when a recursive algorithm is desired, as a strong interconnection between the co-ordinates is created. This is illustrated in the following. For a closed loop multibody system or a constrained multibody system, a relationship is created between the joint co-ordinates. These constraints can be expressed as a set of algebraic equations:

Φ(q,t)=0 [1]

Instead of dealing with these generally non-linear equations, a time derivative can be taken to obtain a set of linear equations in the joint velocities.

$${Φ}_{q} \dot{q} = - \frac{\partial Φ}{\partial t} \qquad [ 2 ]$$

whereby

$${Φ}_{q} = \frac{\partial Φ}{\partial q}$$

is the Jacobian matrix of the constraint equations and

$$\frac{\partial Φ}{\partial t}$$

is the partial derivative of the constraint equations with respect to time. As the co-ordinates are related to each other by means of the algebraic equations, it is possible to make a partition in dependent q_{d} and independent qᵢ co-ordinates. The choice is not always arbitrary, it mainly depends on numerical issues.

$${Φ}_{{q}_{d}} {\dot{q}}_{d} + {Φ}_{{q}_{i}} {\dot{q}}_{i} = - \frac{\partial Φ}{\partial t} \qquad [ 3 ]$$

The dependent joint velocities are then equal to:

$${\dot{q}}_{d} = - {Φ}_{{q}_{d}}^{- 1} ( {Φ}_{{q}_{i}} {\dot{q}}_{i} + \frac{\partial Φ}{\partial t} ) \qquad [ 4 ]$$

An incorrect partitioning will lead to singularity or at least bad conditioning of Φ_{q}_{_{d}}. In general, the dependent velocities will be functions of all independent velocities. The latter inhibits the possibility to obtain recursively formulated equations of motion. The latter solution therefore does not allow to efficiently determine the motion of a constrained mechanical system comprising multiple bodies.

In other words, the standard techniques can be used for simulating the motion of these constrained multibody systems, but the strong interdependency of the co-ordinates and their velocities makes it difficult to tailor a O(n) recursive algorithm.

### SUMMARY OF THE INVENTION

It is an object of the present invention to provide a method and system for efficiently simulating the motion of a constrained mechanical system comprising multiple bodies. The above objective is accomplished by a method and device according to the present invention.

The invention relates to a method and apparatus of using equations of motion of a constrained mechanical system comprising multiple bodies to calculate at least position related information of the constrained mechanical system, wherein said equations of motion are recursively formulated Hamiltonian equations of motion, said method comprising calculating at least position related information of the constrained mechanical system from the equations and boundary conditions. Constraints of the constrained mechanical system may be determined by boundary conditions for the system.

The constrained mechanical system may be constrained by a set of constraints defining a constraint subspace. The constrained mechanical system furthermore may comprise at least one fixed joint and at least one further joint constrained by at least one constraint of the set of constraints. The method may comprise, for each K^{th} body of the constrained mechanical system, determining a quantity related to a constrained articulated momentum vector of said K^{th} body, said constrained articulated momentum vector of said K^{th} body being the sum of a momentum vector of the K^{th} body of the system and the projected constrained articulated momentum vectors of adjacent bodies that are located closer to said at least one further joint, said projected constrained articulated momentum vectors being projected on said constraint subspace and referring to a local reference frame of the K^{th} body, and thereafter using said quantities related to said constrained articulated momentum vectors for obtaining a set of Hamiltonian equations of motion for said constrained mechanical system. Obtaining a set of Hamiltonian equations of motion may comprise, for generalized co-ordinates q, conjugated canonical momenta p, and time t, obtaining expressions for the time derivatives of the generalized co-ordinates q and the time derivatives of the conjugated canonical momenta p

\dot{q}=F(q,p,t)

\dot{p}=G(q,p,t)

These expressions for the time derivatives may determine the motion of each of said multiple bodies.

Determining a quantity related to a constrained articulated momentum vector of said K^{th} body may comprise determining a constrained articulated momentum vector P_{K}^{c} given by

$${P}_{K}^{c} = {P}_{K} + {\sum }_{j ∈ AOB} {}_{}^{K}{T}{}_{j}^{F} {C}_{j}^{T} {P}_{j}^{c}$$

wherein P_{K} is said momentum vector of the K^{th} body, the set AOB comprises all adjacent outboard bodies, i.e. all bodies adjacent to body K and being closer to the at least one further joint than body K, Cⱼ^{T}Pⱼ^{c} is said projection of the constrained momentum vector of an adjacent body closer to the at least one further joint and ^{K}Tⱼ^{F} is a transformation matrix transforming the projection of the constrained momentum vector Cⱼ^{T}Pⱼ^{c} referred to a local reference frame of a j^{th} body to the projection of the constrained momentum vector Cⱼ^{T}Pⱼ^{c} referred to said local reference frame of said K^{th} body. Said method furthermore may comprise using a principle of virtual power.

The constrained mechanical system, being constrained by a set of constraints defining a constraint subspace, may furthermore comprise at least one fixed joint and at least one further joint constrained by at least one constraint of the set of constraints, whereby the method may comprise, for each K^{th} body of the constrained mechanical system, the K^{th} body comprising a set of dependent bodies of K, determining a quantity related to a constrained articulated momentum vector of said K^{th} body, said constrained articulated momentum vector of said K^{th} body being the sum of the articulated momentum vector of body K and a linear function of all the dependent canonical momenta conjugate to the dependent bodies, and using said quantities related to said constrained articulated momentum vectors for obtaining a set of Hamiltonian equations of motion for said constrained mechanical system. The method may comprise determining the constrained articulated momentum vector of said K^{th} body. The dependent canonical momenta conjugate to dependent body i may be considered as the canonical momentum if the system was not constrained. Obtaining a set of Hamiltonian equations of motion may comprise, for generalized coordinates q, conjugated canonical momenta p, and time t, obtaining expressions for the time derivatives of the generalized coordinates q and the time derivatives of the conjugated canonical momenta p

\dot{q}=F(q,p,t)

\dot{p}=G(q,p,t)

Determining a quantity related to a constrained articulated momentum vector of said K^{th} body comprises determining a constrained articulated momentum vector

$${P}_{K}^{c} given by {P}_{K}^{c} = {P}_{K}^{⋆} + {\sum }_{i ∈ dep ( K )} {}_{}^{K}{T}{}_{j}^{F} {C}_{{q}_{i}}^{⋆} {E}_{i}^{T} {P}_{i}^{⋆}$$

wherein P*_{K} is the articulated momentum vector of articulated body K, the set dep(K) comprises all bodies dependent on body K and Eᵢ^{T}P*ᵢ is the dependent canonical momenta conjugate to dependent body i, ^{K}Tᵢ^{F} is a transformation matrix transforming a description of a force or momentum vector with respect to a reference frame associated to body i to a description of the same force or momentum vector with respect to a reference frame associated to body K, and C*_{q}_{ᵢ} is a function of the matrix C representing the constraints of the multibody system. The dependent canonical momenta conjugate to dependent body i may be considered as the canonical momentum if the system was not constrained. The above may alternatively be described as the articulated momentum vector of articulated body K being equal to the combination of the momentum vectors of all bodies comprised in the considered articulated body as if it were one single body and one additional contribution ^{K}Tᵢ^{F}C*_{q}_{ᵢ}Eᵢ^{T}P*ᵢ for each dependent body i to account for the constraints.

The method comprises arbitrary selecting a number of dependent bodies in said constrained mechanical system.

The invention furthermore relates to a method for determining, over a number of time steps δt, motion of a constrained mechanical system comprising multiple bodies, the method comprising obtaining a set of Hamiltonian equations of motion for said constrained mechanical system, and, for each of said number of time steps δt, recursively calculating at least position related information of said multiple bodies of said constrained mechanical system based on said set of Hamiltonian equations of motion. The method may furthermore comprise visualising, simulating or predicting motion at least position related information of said multiple bodies of said constrained mechanical system. Determining motion may be visualising, simulating or predicting motion.

The set of Hamiltonian equations of motion may comprise, for generalized co-ordinates q, conjugated canonical momenta p, and time t, expressions for the time derivatives of the generalized co-ordinates q and of the conjugated canonical momenta p

\dot{q}=F(q,p,t)

\dot{p}=G(q,p,t)

Recursively calculating may comprise:

backward recursively calculating a constrained articulated mass matrix for the constrained mechanical system,

forward recursively calculating the time derivatives of the generalised co-ordinates q,

backward recursively calculating constrained accumulated force vectors, each constrained accumulated force vector expressing the accumulated force on the body under study, and

determining the time derivatives of the conjugated canonical momenta p.

The method may furthermore comprise forward recursively calculating in order to determine a further constraint matrix and during said first backward recursively calculating, reversing the recursion direction when a last dependent body is met.

Obtaining a set of Hamiltonian equations of motion for said constrained mechanical system may comprise determining a set of equations of motion according to any of the methods according to the present invention for determining equations of motion of a constrained mechanical system.

Obtaining a set of Hamiltonian equations of motion for said constrained mechanical system may comprise inputting a set of Hamiltonian equations of motion from a data source.

The motion may comprise the forward dynamics of said constrained mechanical system. The method may comprise studying an impact on said constrained mechanical system based on a sudden change in said generalized co-ordinates q or said conjugated canonical momenta p. The method may comprise studying multiple bodies in contact with each other. The multiple bodies may be rigid bodies, each body connected to at least another body of said multiple bodies with a joint. Determining motion may be applied in any of virtual prototyping, virtual reality or computer animation.

The invention furthermore relates to a computing device for determining the motion over a number of time steps δt of a constrained mechanical system comprising multiple bodies, the computing device comprising means for obtaining data relating to a set of Hamiltonian equations of motion for said constrained mechanical system, and means for recursively computing, for each of said number of time steps δt, at least position related information of said multiple bodies of said constrained mechanical system based on said set of Hamiltonian equations of motion. Determining the motion may be computing the motion. Determining motion also may comprise visualising, simulating and/or predicting at least position related information of said multiple bodies of said constrained mechanical system.

The invention also relates to a computer program product to be utilized with a computer system for determining over a number of time steps δt the motion of a constrained mechanical system comprising multiple bodies, the computer program product comprising instruction means for obtaining data relating to a set of Hamiltonian equations of motion for said constrained mechanical system, and instruction means for computing, for each of said number of time steps Δt, at least position related information of said multiple bodies of said constrained mechanical system based on said set of Hamiltonian equations of motion. Determining motion may be visualising, simulating and/or predicting motion. Determining motion also may comprise visualising, simulating and/or predicting at least position related information of said multiple bodies of said constrained mechanical system.

The invention furthermore relates to a machine readable data storage device storing the computer program product to be utilized with a computer system for determining over a number of time steps δt the motion of a constrained mechanical system comprising multiple bodies, the computer program product comprising instruction means for obtaining data relating to a set of Hamiltonian equations of motion for said constrained mechanical system, and instruction means for computing, for each of said number of time steps δt, at least position related information of said multiple bodies of said constrained mechanical system based on said set of Hamiltonian equations of motion. Determining motion may be visualising, simulating and/or predicting motion. Determining motion also may comprise visualising, simulating and/or predicting at least position related information of said multiple bodies of said constrained mechanical system.

The invention also relates to transmission of a computer program product, as described above, over a telecommunications network. The network may be a local area telecommunications network.

The present invention also provides a method for determining motion of a

constrained mechanical system having multiple bodies, comprising

backward recursively calculating a constrained articulated mass matrix for the constrained mechanical system,

forward recursively calculating time derivatives of generalised co-ordinates q of the constrained mechanical system,

backward recursively calculating constrained accumulated force vectors, each constrained accumulated force vector expressing an accumulated force on the constrained mechanical system, and

determining time derivatives of conjugated canonical momenta p.

Determining motion may be visualising, simulating and/or predicting motion. Determining motion also may comprise visualising, simulating and/or predicting at least position related information of said multiple bodies of said constrained mechanical system.
The method furthermore may comprise forward recursively calculating in order to determine a further constraint matrix and during said backward recursively calculating, reversing the recursion direction when a last dependent body is met.
The present invention also provides a computer based system for determining motion, the system comprising means for backward recursively calculating a constrained articulated mass matrix for the constrained mechanical system, means for forward recursively calculating time derivatives of generalised co-ordinates q of the constrained mechanical system,
means for backward recursively calculating constrained accumulated force vectors, each constrained accumulated force vector expressing an accumulated force on the constrained mechanical system, and
means for determining time derivatives of conjugated canonical momenta p. Determining motion may be visualising, simulating and/or predicting motion. Determining motion also may comprise visualising, simulating and/or predicting at least position related information of said multiple bodies of said constrained mechanical system.

It is an advantage of the method and system for simulating motion of multibody systems according to the present invention that the number of arithmetical operations needed to obtain good simulation results for multibody systems with a high number of bodies, i.e. for example a system having at least 8 bodies, is limited, i.e. reduced compared to prior art techniques.

It is also an advantage of the present invention that it allows to obtain the equations of motion with a good evolution of the constraints violation errors, i.e. with less constraints violation errors than in prior art techniques.

It is furthermore also an advantage of the present invention that the method for closed loop mechanical systems also can be used for open loop mechanical systems by selecting specific values for certain parameters in the simulation method and system.

It is also an advantage of the present invention that it can be used for calculating the forward dynamics of a mechanical system, studying an impact on a mechanical system and studying the contact between different bodies, as bodies in contact can be treated as a multibody system with changing topology.

The teachings of the present invention permit the design of improved methods and systems for simulating the motion of constrained mechanical multibody systems.

These and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 shows a flow chart for a method of determining a set of equations of motion indicating the different steps performed to obtain a set of Hamiltonian equations for the description of the forward dynamics of a closed loop multibody system according to a first embodiment of the invention.

FIG. 2 is a schematic illustration of how numbering in a closed loop system for methods according to embodiments of the present invention can be obtained.

FIG. 3a is a schematic illustration of an object with a first fixed end joint and a second end joint mounted shiftable along a rod as can be described by a system and method according to embodiments of the present invention.

FIG. 3b is a schematic illustration of an object having a fixed end and a loop as can be described by a system and method according to embodiments of the present invention.

FIG. 4 is a flow chart of the different steps of a method for computing and/or simulating the forward dynamics of a constrained mechanical multibody system, according to a second embodiment of the present invention.

FIG. 5a is an example of a constrained mechanical system being a planar chain with both ends fixed and having the last two bodies as dependent bodies, according to a third embodiment of the present invention.

FIG. 5b is an example of a constrained mechanical system being a planar chain with both ends fixed and having the first and the third body as dependent bodies, according to a third embodiment of the present invention.

FIG. 6 is a flow chart of the different steps of a method for computing and/or simulating the forward dynamics of a constrained mechanical multibody system, according to a fourth embodiment of the present invention.

FIG. 7 is a schematic representation of a computer system in accordance with an embodiment of the present invention.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

It is to be noticed that the term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

The present invention allows an efficient determination or simulation of the motion of constrained mechanical multibody systems. Determination of motion may be simulation, prediction or visualisation of motion. The invention will be focussed on using Hamiltonian formalism in recursive algorithms for the forward dynamics of constrained mechanical multibody systems. In the following, constrained mechanical multibody systems also will be referred to as closed loop mechanical multibody systems. Typically, for closed loop mechanical multibody systems, the topology is studied. In the present application, the terms “constrained multibody systems” and “closed loop systems” are not only used for systems having no open or free ends, but also for systems combining a part of a system having no open ends and a part of a system having one or more open ends. The present invention can also be used for such systems combining constrained mechanical multibody subsystems and unconstrained mechanical multibody systems. For dealing with such systems, these systems are divided into the constrained subsystem, which is studied with a method according to the present invention, and the unconstrained subsystem which may be studied with any suitable method, including the method of the present invention whereby no constraint equations are imposed. In the following, only calculating a constrained system or a constrained subsystem is dealt with.

The number of constraints present in the closed loop mechanical multibody system can be one, two, three or more. The number of constraints depends on the number of bodies and on the type of joints in between the bodies. Furthermore, the mechanical system is not limited to a single loop or to a system that is only constrained at two ends of the multibody system. The constraints may be any kind of kinematic constraint between the bodies, including rheonomic constraints. In the present application, with multibody systems it is meant every mechanical system comprising multiple bodies. The multibody system may be a number of rigid bodies connected by joints or may be a number of free bodies, e.g. in contact with each other, or a combination thereof. The types of joints used in systems comprising connected bodies is not limiting the present invention. The joints can e.g. be rotational joints or translational joints. The present invention is described for bodies wherein no deformation is present, although it may be obvious for a person skilled in the art that extension to deformable bodies can be performed.

The explicit mathematical language that can be used to describe the invention can be e.g. matrix-algebra, vector algebra or the corresponding vector space representation, but the invention is not limited thereto. Other ways of performing the computation according to the embodiments of the present invention can be e.g. by applying neural networks. Furthermore, the formulation of the embodiments of the present invention can be done using different mathematical languages in a single description. Concepts introduced by vector algebra can be equally represented using matrix algebra or using the vector space representation and vice versa. The current description of the embodiments of the present invention is, by way of example, done using vector and matrix algebra. The different physical relations and the constraints with which the mechanical multibody system needs to comply are expressed using equations. Typically the number of equations for describing a constrained system is larger than for describing an unconstrained system. The constraints are expressed by way of a number of constraint equations. In the vector space representation, the constraint equations define a constraint subspace, to (part of) which the solutions of mathematical equations or values of physical quantities need to be restricted if the solutions of the mathematical equations or physical quantities need to be in agreement with the constraints.

The methods of the present invention will be based on recursive formulations of the equations of motion. Recursive formulations define the entity being defined partially in terms of itself. In other words recursive formulations are formulations where there is an element of self reference, i.e. the entity is defined partially by reference to itself. Recursive formation also may be defined as a formulation of a function from which values of the function can be calculated significantly accurately in a finite number of steps.

The methods of the present invention will be based on Hamiltonian equations of motion. Hamiltonian formulations of the equations of motion of mechanical systems in general are well known by the person skilled in the art. Hamiltonian formulations of the equations of motion typically are formulations of the equation of motion expressed as a function of generalized coordinates and canonical momenta.

In a first embodiment of the present invention, a method is described for using a set of equations of motion which allow to determine motion of a constrained mechanical system. The constrained mechanical system may be a constrained multibody system. The method is based on obtaining a Hamiltonian form of the equations of motion of a constrained multibody system. The constraints may involve a closed loop multibody system. The general Hamiltonian form of the equations of motion can be expressed by time derivatives of the generalised co-ordinates q and time derivatives of the conjugated canonical momenta p:

$$\{ \begin{matrix}\dot{q} = F ( q , p , t ) \\ \dot{p} = G ( q , p , t )\end{matrix} \qquad [ 5 ]$$

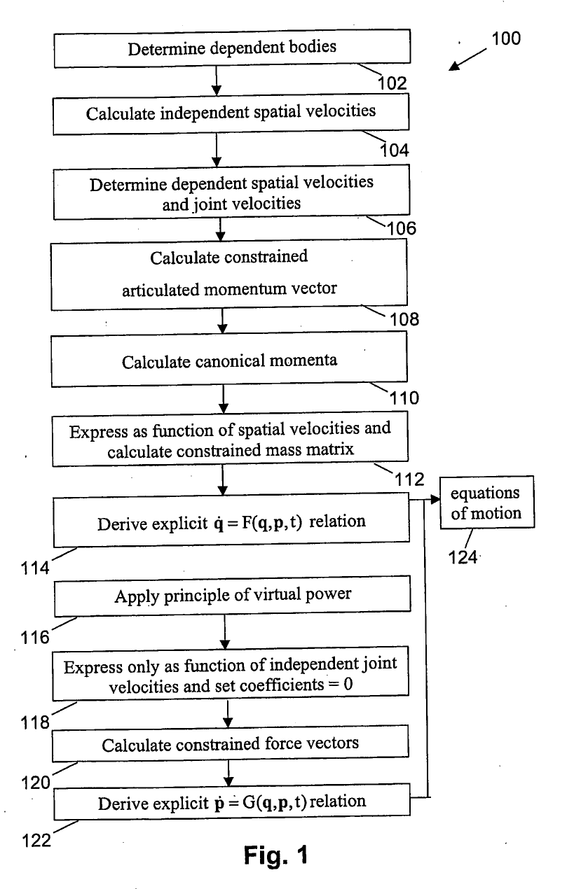

For a multibody system, each of the bodies will be described by an equation for the time derivatives of its generalised co-ordinates q and its conjugated canonical momentum p. The embodiments of the present invention provide a recursive formulation for the equations of motion such that the dynamics of a constrained mechanical system comprising multiple bodies can be calculated. Determining the motion of a constrained mechanical system may be visualising, simulating, predicting or calculating the motion of a constrained mechanical system. An illustration of a possible way to obtain a set of Hamiltonian equations of motion allowing recursive formulation is shown in FIG. 1. The different steps of the method 100 for obtaining the equations of motion are shown in the flow chart in FIG. 1. The method 100 comprises the step of determining the dependent bodies in the multibody system, i.e. step 102, followed by determining expressions for the independent spatial velocities, i.e. step 104, and determining expressions for the dependent spatial velocity and the dependent joint velocity, i.e. step 106. In order to obtain expressions for the first set of equations being part of the equations of motion, i.e. \dot{q}=F(q,p,t), expressions for the constrained articulated momentum vector are determined, i.e. step 108, which allows to determine expressions for the conjugated canonical momenta, i.e. step 110. The conjugated canonical momenta, i.e. the projection of the articulated constrained momentum vector then is expressed as a function of the spatial velocities, i.e. step 112, leading to determination of the constrained mass matrix. These equations allow to determine explicit relations for the joint velocity \dot{q}=F(q,p,t), i.e. step 114. By expressing the principle of virtual power, i.e. expressing that the reaction forces acting on a mechanical system do not deliver any power under a virtual motion, i.e. step 116, an equation as a function of only independent joint velocities can be obtained, i.e. step 118. Based on the independency of the joint velocities and the fact that such an expression should be valid for any set of virtual velocities, the coefficients of this expression can be set equal to zero. The latter expressions allow to obtain explicit relations \dot{p}=F(q,p,t), i.e. step 122, whereby the constrained accumulated force vector, present in these relations and function of the momentum vector of corresponding body, is determined using backward recursion, i.e. step 120. Combining \dot{q}=F(q,p,t) and \dot{p}=F(q,p,t) leads to a set of equations of motion [5], i.e. step 124.

In the following, a possible way of applying the different steps of method 100 is given in a more detailed way. It will be obvious for the person skilled in the art that the explicit algorithms for performing the steps of method 100 are only given by way of illustration and that different algorithms for performing any or each step may be applied without leaving the scope of the invention.

In step 102 of the dynamical analysis of constrained multibody systems, the bodies which are considered as dependent bodies in the multibody system are determined. In the present application, a dependent body is defined as a body in the multibody system the conjugated co-ordinates of which are dependent. The number of dependent bodies is determined by the number of constraints and the type of joints, i.e. the number of degrees of freedom of the joints, of these dependent bodies. For example, a pin-joint has a degree of freedom of 1, whereas a spherical joint has a degree of freedom of 3. A valid set of dependent bodies is obtained if the sum of the degrees of freedom of the joints of the dependent bodies is equal to the number of constraints. The number of dependent bodies thus is not fixed, but it depends on the kind of joints of the selected dependent bodies. The numbering of the bodies and the joints is done based on the same principles as this is usually done for open loop systems. The body at the fixed end, i.e. the body connected to the wall, floor, etc. has the lowest number and the bodies are numbered with a higher number if they are closer to a further joint constrained by a constraint of a set of constraints. The further joint can e.g. be the end of a loop, a slideable connection of the multibody system to an environmental feature, etc. The number of further joints is not limited to one in the present application but can be two, three or more.

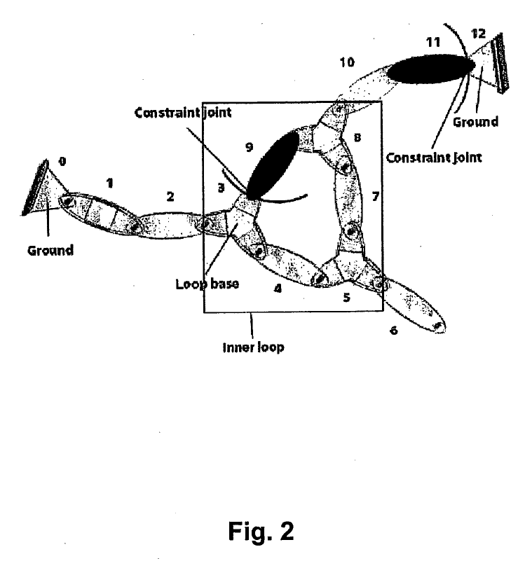

For a specific body, an outboard body is a body that is positioned closer to the further joint than the body itself, while with inboard body, there is referred to a body that is further away from a further joint than the body under consideration. In other words, the numbering of the bodies and the definition of the outboard and inboard bodies of a certain body can be done as follows. First a base of the system is chosen. This can often be done in different valid ways. Typically, the base is chosen as a body connected to a non-moving reference frame, such as e.g. a wall, a ceiling, etc. The non-moving reference frame itself will get number 0, the base body will get number 1. The base body can have one or more bodies connected to it. If this is the case, the base body is called a parent, and the other body/bodies directly connected to the parent are the children. Children always have a higher number and are adjacent outboard bodies of the parent. Parents always have a lower number as their children and are always inboard bodies compared to these children. A child body K always has one single parent, indicated as Pa(K), but can have one or more children bodies connected to it, indicated as Ch(K). These one or more children bodies are outboard bodies for child body K, and have a higher identification number than the child body K. The numbering is done until a tip of an open end is reached, until the non-moving reference is reached or till a body is reached that has been numbered already. In order to illustrate the numbering in a closed loop system, the cutting of joints is illustrated in FIG. 2. FIG. 2 illustrates a closed-loop system with two kinematic loops. There are two connections with the ground, indicated by numbering 0 and 12, and one inner loop, indicated by bodies 3 to 9. An open loop system is obtained by breaking certain joints. The joint between bodies 9 and 3 and the joint between bodies 11 and 12 can e.g. be selected to be broken up. The removed joints are called constraint joints. When sweeping through the tree in the outboard direction, the first element of an inner loop that is encountered is called the loop base. In FIG. 2, this is body 3. It has one child, i.e. body 4. Body 9 only is a descendant.

In the following steps the transformation matrices ^{K}T_{K-1}^{V} and ^{K}T_{K-1}^{F} will be used. These transformation matrices are strongly related to each other and express how a spatial velocity vector respectively a spatial force vector changes from point to point. These transformation matrices thus are used to use specific physical quantities described in the reference frame of another body, e.g. body K−1, in the local reference frame of the body under study, e.g. body K. By convention, the reactions from body N are taken with respect to point O_{N} on the joint axis. To transmit these reactions to origin O_{K}, the transformation matrix ^{K}T_{K-1}^{F} is defined as

$${}_{}^{K}{T}{}_{K - 1}^{F} = ( \begin{matrix}I & O \\ {O}_{K} {O}_{N} & I\end{matrix} ) \qquad [ 6 ]$$

In similar way ^{K}T_{K-1}^{V} can be defined, whereby ^{K}T_{N}^{F}=(^{N}T_{K-1}^{V})^{T}. It is to be noted that this matrix is constant in the local reference frame.

In a second step 104, the independent spatial velocities Ω_{K} of a body K are expressed as a function of the spatial velocity of the adjacent inboard body. This can e.g. be done by taking the sum of this spatial velocity and the relative velocity \dot{q}_{K}.

Ω_{K}=^{K}T_{K-1}^{V}Ω_{K-1}+E_{K}\dot{q}_{K} [7]

The matrix E_{K} thereby is the joint matrix of the K^{th} body. The column vectors of the joint matrix form a basis for the space of virtual motions. In step 106 the dependent spatial velocities and joint velocities are determined. The spatial velocity of a dependent body are expressed as a function of spatial velocity of the adjacent inboard bodies. This is described in more detail by Anderson and Critchley, in Multibody System Dynamics 9, (2003) p 185-212. The spatial and joint velocities can be e.g. found with following recursion steps:

\dot{q}_{K}=C_{q}_{_{K}}^{TK}T_{K-1}^{V}(Ω_{K-1}−^{K-1}T_{L}^{V}Ω_{L}) [8]

Ω_{K}=C_{K}^{K}T_{K-1}^{V}(Ω_{K-1}−^{K-1}T_{L}^{V}Ω_{L})+^{K}T_{L}^{V}Ω_{L} [9]

with

C_{q}_{_{K}}^{T}=−(E_{K}^{TK}T_{K+1}^{F}C*_{K+1}^{K+1}T_{K}^{V}E_{K})⁻¹(E_{K}^{TK}T_{K+1}^{F}C*_{K+1}^{K+1}T_{K}^{V}) [10]

C_{K}=I+E_{K}C_{q}_{_{K}}^{T} [11]

C*_{K}=^{K}T_{K+1}^{F}C_{K+1}^{K+1}T_{K}^{V}C_{K} [12]

K stands for all dependent bodies related to the considered further joint. L is the base body or specific body of the further joint. When that body is the ground, the spatial velocity ΩL of body L is zero. In this case, the latter also can be referred to as the spatial velocity Ω_{C} of body C whereby C indicates the environment, but the spatial velocity Ω_{C} of body C is expressed in a different reference frame than the spatial velocity Ω_{L} of body L. The matrix C is the matrix representation of the constraints of the multibody system. It thus is possible to obtain the dependent velocities without direct use of the Jacobian matrix. Using this method, a recursive algorithm for the forward dynamics of closed loop systems will be possible.

The conjugated canonical momenta conjugated to the joint co-ordinates are now further calculated in the following steps. In step 108, the constrained articulated momentum vector is calculated. The momentum vector of a rigid body is defined as

P_{K}=M_{K}Ω_{K} [13]

wherein M_{K} is the mass of body K and Ω_{K} is its spatial velocity. The articulated momentum vector of a body is the sum of the momentum vector of that body and of all outboard bodies reduced to it.

$${P}_{K}^{⋆} = {P}_{K} + {\sum }_{i ∈ OB} {}_{}^{K}{T}{}_{i}^{F} {P}_{i} = {P}_{K} + {\sum }_{j ∈ AOB} {}_{}^{K}{T}{}_{j}^{F} {P}_{j}^{⋆} \qquad [ 14 ]$$

Defining the articulated momentum vector for every body of the multibody system whereby OB stands for ‘outboard bodies’, AOB for ‘adjacent outboard bodies’. The constrained articulated momentum vector finally, is defined as:

$${P}_{K}^{c} = {P}_{K} + {\sum }_{j ∈ AOB} {}_{}^{K}{T}{}_{j}^{F} {C}_{j}^{T} {P}_{j}^{c} \qquad [ 15 ]$$

The latter expression allows that in the present invention a recursive algorithm for the equations of motion based on the Hamiltonian formalism is obtained. The constrained articulated momentum vector is defined for all bodies K, and is defined as the summation of the momentum vector of the body under study with the projected constrained articulated momentum vectors of all adjacent outboard bodies, whereby the projection is done on the subspace of the constraints, and whereby this quantity is transformed in a quantity in the local reference frame of body K. Bodies K for which C_{q}_{_{K+1}}=0 have the same constrained articulated momentum and articulated momentum vectors.

In step 110, the conjugated canonical momenta are calculated. To calculate the conjugated canonical momenta, the partial derivatives of the spatial velocities to the independent co-ordinates are needed. For the independent spatial velocities, one gets:

$$\begin{matrix}\frac{\partial {Ω}_{{K}_{ind}}}{\partial {\dot{q}}_{i}} = 0 i > K & [ 16 ] \\ \frac{\partial {Ω}_{{K}_{ind}}}{\partial {\dot{q}}_{i}} = {E}_{K} i = K & [ 17 ] \\ \frac{\partial {Ω}_{{K}_{ind}}}{\partial {\dot{q}}_{i}} = {}_{}^{K}{T}{}_{K - 1}^{V} \frac{\partial {Ω}_{K - 1}}{\partial {\dot{q}}_{i}} & [ 18 ] \\ \frac{\partial {Ω}_{{K}_{ind}}}{\partial {\dot{q}}_{i}} = {}_{}^{K}{T}{}_{i}^{V} {E}_{i} i < K & [ 19 ]\end{matrix}$$

As mentioned above, the numbering of the links happens the same way as for open-loop systems, but the further joints are first cut for that purpose. Thus, an outboard always point to a further joint or an open end. As for open-loop systems, an outboard body gets a higher identification number than the body K under study. The numbering may differ if a complex multibody system is described having multiple further joints. For the dependent velocities, following recursive equations hold:

$$\begin{matrix}\frac{\partial {Ω}_{{K}_{dep}}}{\partial {\dot{q}}_{i}} = {}_{}^{K}{T}{}_{K - 1}^{V} \frac{\partial {Ω}_{K - 1}}{\partial {\dot{q}}_{i}} i \leq L & [ 20 ] \\ \frac{\partial {Ω}_{{K}_{dep}}}{\partial {\dot{q}}_{i}} = {{C}_{K}}^{K} {T}_{K - 1}^{V} \frac{\partial {Ω}_{K - 1}}{\partial {\dot{q}}_{i}} i > L & [ 21 ]\end{matrix}$$

i is always smaller than the identification number of dependent bodies K_{dep}, as no partial derivatives with respect to dependent co-ordinates are taken. The conjugated canonical momenta can now be calculated. Taking the definition

$$\begin{matrix}{p}_{K} = \frac{\partial T}{\partial {\dot{q}}_{K}} = {\sum }_{i = 0}^{N} \frac{\partial {Ω}_{i}^{T}}{{\dot{q}}_{K}} {P}_{i} = {\sum }_{i = ind} \frac{\partial {Ω}_{i}^{T}}{{\dot{q}}_{K}} {P}_{i} + {\sum }_{i = dep} \frac{\partial {Ω}_{i}^{T}}{\partial {\dot{q}}_{K}} {P}_{i} & [ 22 ] \\ one gets & \\ {P}_{K} = {E}_{K}^{T} {P}_{K}^{c} = {\sum }_{i = 0}^{N} \frac{\partial {Ω}_{i}^{T}}{\partial {\dot{q}}_{K}} {P}_{i} & [ 23 ]\end{matrix}$$

The conjugated canonical momenta are thus the constrained momentum vectors projected on the joint subspaces. The introduction of the constrained momentum vector will enable the construction of the recursive Hamiltonian algorithm for closed loop systems.

In step 112, the conjugated canonical momenta or the projection of the constrained momentum vectors on the joint subspaces are expressed as function of the spatial velocities. This can be obtained using equation [15] which expresses the constrained momentum vector as a function of the momentum vector of the body and the momentum vectors of the adjacent outboard bodies. The momentum vectors then can be expressed as a function of the mass and the spatial velocity, i.e. using equation [13]. This leads to an expression of the constrained momentum vector as function of the spatial velocity of that body.

In step 114, the expression for the conjugated canonical momenta can be used to derive explicit expressions for the time derivative of the generalised co-ordinate \dot{q}=F(q,p,t). This is a first set of equations that is part of the Hamiltonian equations of motion.

In the previous steps, half of the Hamiltonian equations were found, namely the ones calculating the time derivatives \dot{q} of the generalised co-ordinates. The other half, which calculates the joint velocities, can be found using the constrained momentum vector P^{c}. This can be done by applying the following steps.

In step 116, the principle of virtual power is applied to the constrained multibody problem. The principle of virtual power states that reaction forces acting on a mechanical system do not deliver any power under a virtual motion. It can be expressed under following form:

$${\sum }_{i} ⌊ {Ω}_{i}^{⋆ T} ( {\dot{P}}_{i} + {Ω}_{i} \times {P}_{i} - {T}_{i} ) ⌋ = 0 \qquad [ 24 ]$$

Ωᵢ* being a virtual spatial velocity, Pᵢ the momentum vector and Tᵢ the spatial external force vector for body i. In other words, the summation of the products of any virtual spatial velocity of a body with the reaction forces acting on that body must be set equal to zero. After expressing the virtual spatial velocities as functions of the co-ordinate velocities and the dependent co-ordinate velocities as functions of the independent ones, above equations can be uncoupled in a set of 2n first order differential equations, n being the number of degrees of freedom (DOF) of the system. A problem arises when using the Jacobian, as it introduces a strong interdependency of these equations, disabling or making difficult the possibility of tailoring a recursive O(n) method. This is why steps 102 to 106 are used in the present method 100.

In step 118, the corresponding equations are expressed only as a function of the independent joint velocities. The coefficients in the thus obtained expressions are set equal to zero.

One can write the principle of virtual power as a function of only independent joint velocities to get an expression of following form:

$${\sum }_{i = ind} {A}_{i} {\dot{q}}_{i}^{⋆} = 0 \qquad [ 25 ]$$

As the considered joint velocities are independent and above expression must hold for any set of virtual velocities, the coefficients Aᵢ must be equal to zero. This is equivalent to the statement that the partial derivatives of the left hand side of equation [24] relative to the independent virtual joint velocities must be zero.

In step 120, the constrained accumulated force vectors, expressing the total force acting on a body of the multibody system, are defined by a backward recursive equation.

The equations obtained in step 118 are used to derive explicit expressions for the \dot{p}=F(q,p,t) relation, i.e. step 122.

In step 124, combination of the obtained \dot{q}=F(q,p,t) and \dot{p}=F(q,p,t) results in a set of equations of motion. In this way, a Hamiltonian formulation of the equations of motion are defined in a recursive way.

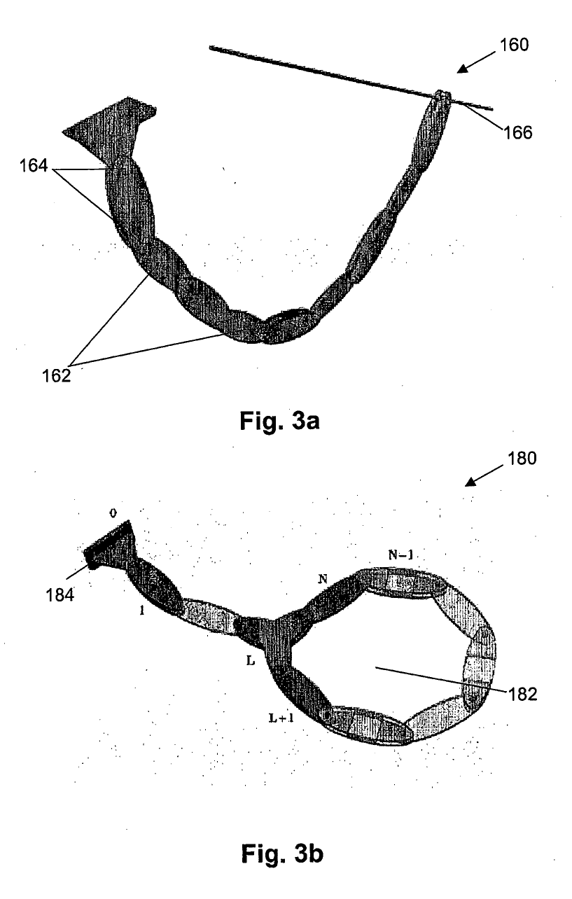

In the following, two explicit examples of the determination of the equations of motion for the simulation of the motion of a constrained multibody system are given. The first example 160 is an illustration for the movement of a planar chain with N chain links 162, whereby a first end of the chain is fixed to a non-moving environment such as e.g. to a wall or a ceiling by means of a joint, for example a pin-joint 164, while the second end of the chain is movably attached, e.g. slidably attached to a fixed rod 166. An example of such a chain is shown in FIG. 3a. The second example 180 is an illustration of a planar chain comprising N chain links, and wherein a loop 182 is present. The system is illustrated in FIG. 3b.

### Example 1

The first example 160 is a planar chain with N links 162, in the example shown in FIG. 3a there are nine links 162; one end is fixed to the non-moving environment by means of a pin-joint 164, and the other end is attached so as to be able to slide along a fixed rod 166. There are N+2 joint co-ordinates: one for each pin-joint 164 and an additional 2 for the ends of the chain. The number of degrees of freedom (DOF) is N−1, which means that 3 co-ordinates are to be chosen as dependent. The method described above will now be applied to obtain a set of Hamiltonian equations of motion. One can choose the co-ordinates related to the last body and the constraint as dependent co-ordinates: q_{N} and q_{c}, the last vector being a vector with 2 co-ordinates. The motion of a rigid body K can be described by the so-called spatial velocity Ω_{K}.

$${Ω}_{K} = {( \begin{matrix}v \\ ω\end{matrix} )}_{K} \qquad [ 26 ]$$

It is possible to express the spatial velocity of a dependent body as a function of the spatial velocity of the adjacent inboard body, as will be shown below:

Ω_{N}=C_{N}^{N}T_{N-1}Ω_{N-1} [27]

The spatial velocity Ω_{C} of the environment, which can also be considered as a virtual body, is zero. Thus, the joint velocities of the further joint can be written as a function of the spatial velocity of the last body:

$$\begin{matrix}{Ω}_{C} = {}_{}^{C}{T}{}_{N}^{V} {Ω}_{N} + {E}_{C} {\dot{q}}_{C} = 0 & [ 28 ] \\ {\dot{q}}_{C} = - {( {E}_{C}^{T} {E}_{C} )}^{- 1} {E}_{C}^{T} {}_{}^{C}{T}{}_{N}^{V} {Ω}_{N} & [ 29 ] \\ = {C}_{{q}_{C}}^{T} {}_{}^{C}{T}{}_{N}^{V} {Ω}_{N} & [ 30 ]\end{matrix}$$

Substitution in equation [28] results in

Ω_{C}=C_{C}^{C}T_{N}^{V}Ω_{N}=0 [31]

with

C_{C}=I+E_{C}C_{q}_{_{C}}^{T} [32]

The last dependent co-ordinate velocity \dot{q}_{N} can also be found as a function of spatial velocity Ω_{N-1}. Indeed, premultiplying equation [31] by E_{N}^{TN}T_{C}^{F} and repeating the procedure gives

$$\begin{matrix}{E}_{N}^{T} {}_{}^{N}{T}{}_{C}^{F} {C}_{C} {}_{}^{C}{T}{}_{N}^{V} ( {T}_{N - 1}^{V} {Ω}_{N - 1} + {E}_{N} {\dot{q}}_{N} ) = 0 & [ 33 ] \\ {\dot{q}}_{N} = - {( {E}_{N}^{T} {}_{}^{N}{T}{}_{C}^{F} {C}_{C} {}_{}^{C}{T}{}_{N}^{V} {E}_{N} )}^{- 1} ( {E}_{N}^{T} {}_{}^{N}{T}{}_{C}^{F} {C}_{C} {}_{}^{C}{T}{}_{N}^{V} ) {}_{}^{N}{T}{}_{N - 1}^{V} {Ω}_{N - 1} & [ 34 ] \\ = {C}_{{q}_{N}}^{T} {}_{}^{N}{T}{}_{N - 1}^{V} {Ω}_{N - 1} & [ 35 ]\end{matrix}$$

It is to be noted that matrix (E_{N}^{TN}T_{C}^{F}C_{C}^{C}T_{N}^{V}E_{N}) needs to be regular. Singularity would be the consequence of a bad partitioning in independent and dependent co-ordinates. After substitution, one gets

Ω_{N}=C_{N}^{N}T_{N-1}^{V}Ω_{N-1} [36]

with

C_{N}=I+E_{N}C_{q}_{_{N}}^{T} [37]

It is to be noted that CC=C, this means that constraint matrix C is a projection operator. CE=0, so C lies in the subspace orthogonal to the space E of virtual movements.

In the following, for example 1, part of the equations of motion \dot{p}=G(q,p,t) will be determined.

q_{c} and q_{N} are dependent co-ordinates. The first encountered independent co-ordinate, starting from the constraint, is q_{N-1}. The only spatial velocities dependent on \dot{q}_{N-1} are Ω_{N-1} and Ω_{N}. Using the principle of virtual power, expressing the equations as functions of the independent co-ordinates and isolating the part in \dot{q}_{N-1}, one gets:

E_{N-1}^{T}(\dot{P}_{N-1}+Ω_{N-1}×P_{N-1}−T_{N-1})+E_{N-1}^{TN-1}T_{N}^{F}C_{N}^{T}(\dot{P}_{N}+Ω_{N}×P_{N}−T_{N})=0 [38]

which gives

\dot{P}_{N-1}^{c}+Ω_{N-1}×P_{N-1}^{c}=T_{N-1}^{c} [39]

with

T_{N-1}^{c}=T_{N-1}+^{N-1}T_{N}^{F}C_{N}^{T}T_{N}+^{N-1}T_{N}^{F}└Ċ_{N}^{T}+C_{N}^{T}(Ω_{N}×I)−(Ω_{N}×I)C_{N}^{T}┘P_{N} [40]

The latter is obtained after some tedious calculation. Projection on the joint subspace of equation [39] results in:

\dot{p}_{N-1}=−E_{N-1}^{T}(Ω_{N-1}×P_{N-1}^{c})+E_{N-1}^{T}T_{N-1}^{c} [41]

The equation of motion conjugated to the other joints K have the same form as for open-loop systems:

\dot{p}_{K}=−E_{K}^{T}(Ω_{K}×P_{K}^{c})+E_{K}^{T}T_{K}^{c} [42]

for which the constrained force vectors are now

T_{K}^{c}=T_{K}+^{K}T_{K+1}^{F}T_{K+1}^{c} [43]

Equation [42] expresses a first part of the Hamiltonian equations of motion. In equation [42], the values of the constrained force vectors can be obtained through backward recursion using equation [43]. It is to be noted that the constrained force vector is a function of the momentum vector of the N^{th} body. In the following, a second part of the Hamiltonian equations of motion will be determined, i.e. \dot{q}=F(q,p,t).

The dependent joint velocities \dot{q}_{C} and \dot{q}_{N-1} were found previously in equations [30] and [35]. Consider body N−1. To find joint velocity \dot{q}_{N-1}, the projection of the constrained momentum vector on the joint axis is needed:

p_{N-1}=E_{N-1}^{T}P_{N-1}^{c}=Eₙ₋₁^{T}(P_{N-1}+^{N-1}T_{N}^{F}C_{N}^{T}P_{N}) [44]

Each term needs to be expressed as function of Ω_{N-1}. One gets

P_{N-1}=M_{N-1}Ω_{N-1} [45]

P_{N}=M_{N}C_{N}^{N}T_{N-1}^{V}Ω_{N-1} [46]

The constrained momentum vector becomes:

$$\begin{matrix}{P}_{N - 1}^{c} = {P}_{N - 1} + {}_{}^{N - 1}{T}{}_{N - 1}^{F} {C}_{N}^{T} {P}_{N} & [ 47 ] \\ = ( {M}_{N - 1} + {}_{}^{N - 1}{T}{}_{N}^{F} {C}_{N}^{T} {M}_{N} {C}_{N} {}_{}^{N}{T}{}_{N - 1}^{V} ) {Ω}_{N - 1} & [ 48 ] \\ = {M}_{N - 1}^{c} {Ω}_{N - 1} & [ 49 ] \\ with {M}_{N - 1}^{c} = {M}_{N - 1} + {}_{}^{N - 1}{T}{}_{N}^{F} {C}_{N}^{T} {M}_{N} {C}_{N} {}_{}^{N}{T}{}_{N - 1}^{V} & [ 50 ]\end{matrix}$$

M_{N-1}^{c} being the constrained mass matrix. The constrained mass matrix relates the spatial velocity of a body to its constrained momentum vector. It can be seen as an extension of the concept of mass for a point to the concept mass matrix for a single rigid body, and the extension of the concept mass matrix for a single rigid body to a set of constrained interconnected bodies. From above equation, the joint velocity \dot{q}_{N-1} can be obtained:

$$\begin{matrix}{p}_{N - 1} = {E}_{N - 1}^{T} {P}_{N - 1}^{c} = {E}_{N - 1}^{T} {M}_{N - 1}^{c} ( {}_{}^{N - 1}{T}{}_{N - 2}^{V} {Ω}_{N - 2} + {E}_{N - 1} {\dot{q}}_{N - 1} ) & [ 51 ] \\ {\dot{q}}_{N - 1} = {( {E}_{N - 1}^{T} {M}_{N - 1}^{c} {E}_{N - 1} )}^{- 1} ( {p}_{N - 1} - {E}_{N - 1}^{T} {M}_{N - 1}^{c} {}_{}^{N - 1}{T}{}_{N - 2}^{V} {Ω}_{N - 2} ) & [ 52 ] \\ = {M}_{{j}_{N - 1}}^{{c}^{- 1}} ( {p}_{N - 1} - {E}_{N - 1}^{T} {M}_{N - 1}^{c} {}_{}^{N - 1}{T}{}_{N - 2}^{V} {Ω}_{N - 2} ) & [ 53 ]\end{matrix}$$

To obtain the next joint velocity \dot{q}_{N-2}, one needs to express P_{N-1}^{c} as a function of Ω_{N-1}.

$$\begin{matrix}{P}_{N - 1}^{c} = {M}_{N - 1}^{c} ( {}_{}^{N - 1}{T}{}_{N - 2}^{V} {Ω}_{N - 2} + {E}_{N - 1} {\dot{q}}_{N - 1} ) & [ 54 ] \\ = {M}_{N - 1}^{c} ( {}_{}^{N - 1}{T}{}_{N - 2}^{V} {Ω}_{N - 2} + {E}_{N - 1} {M}_{{j}_{N - 1}}^{{c}^{- 1}} ( \begin{matrix}{p}_{N - 1} - {E}_{N - 1}^{T} {M}_{N - 1}^{c} \\ {}_{}^{N - 1}{T}{}_{N - 2}^{V} {Ω}_{N - 2}\end{matrix} ) ) & [ 55 ] \\ = {M}_{N - 1}^{′} {}_{}^{N - 1}{T}{}_{N - 2}^{V} {Ω}_{N - 2} + {D}_{N - 1}^{′} & [ 56 ] \\ {M}_{N - 1}^{′} = {M}_{N - 1}^{c} - {M}_{N - 1}^{c} {E}_{N - 1} {M}_{{j}_{N - 1}}^{{c}^{- 1}} {E}_{N - 1}^{T} {M}_{N - 1}^{c} & [ 57 ] \\ {D}_{N - 1}^{′} = {M}_{N - 1}^{c} {E}_{N - 1} {M}_{{j}_{N - 1}}^{{c}^{- 1}} {p}_{N - 1} & [ 58 ]\end{matrix}$$

which is of the same form as for open-loop systems. The remaining joint velocities K can thus be calculated the same way.

Equation [52] illustrates how the Hamiltonian equations of motion for the derivative of the generalised co-ordinates can be obtained, whereby a backward recursion for the constrained mass matrices is needed, expressed by equation [50]. All other Hamiltonian equations of motion for the derivative of the generalised co-ordinate can be obtained by applying forward recursion as is expressed by equations [44] to [58].

Thus, the Hamiltonian equations are determined for example 1, formulated in a recursive way.

### Example 2

Consider the next example. It is a planar chain with a loop. This system has N−2 degrees of freedom, closing the loop introduces 2 additional constraints and one extra joint, which will be described by joint velocity (vector) \dot{q}_{C}. As a consequence, there are 3 dependent co-ordinates. Body C and body L are basically the same, but a different local reference frame is used. The procedure for obtaining the dependent spatial velocities is similar to that used in previous example. Body C has spatial velocity:

Ω_{C}=^{C}T_{N}^{V}Ω_{N}+E_{C}\dot{q}_{C}=^{C}T_{L}^{V}Ω_{L} [59]

The relationship between Ω_{C} and Ω_{L} is described by the velocity field in the rigid body. After projection on subspace E_{C}, one gets:

$$\begin{matrix}{\dot{q}}_{C} = - {( {E}_{C}^{T} {E}_{C} )}^{- 1} {E}_{C}^{T} {}_{}^{C}{T}{}_{N}^{V} ( {Ω}_{N} - {}_{}^{N}{T}{}_{L}^{V} {Ω}_{L} ) & [ 60 ] \\ = {C}_{{q}_{C}}^{T} {}_{}^{C}{T}{}_{N}^{V} ( {Ω}_{N} - {}_{}^{N}{T}{}_{L}^{V} {Ω}_{L} ) & [ 61 ]\end{matrix}$$

Substitution in equation [59] results in

C_{C}^{C}T_{N}^{V}(Ω_{N}−^{N}T_{L}^{V}Ω_{L})=0 [62]

with

C_{C}=I+E_{C}C_{q}_{_{C}}^{T} [63]

This procedure can be repeated recursively for all dependent bodies. The next body N gives (premultiplying by E_{N}^{TN}T_{C}^{F} this time)

$$\begin{matrix}{\dot{q}}_{N} = - {( {E}_{N}^{T} {}_{}^{N}{T}{}_{N + 1}^{F} {C}_{C} {}_{}^{C}{T}{}_{N}^{V} {E}_{N} )}^{- 1} ( {E}_{N}^{T} {}_{}^{N}{T}{}_{C}^{F} {C}_{C} {}_{}^{C}{T}{}_{N}^{V} ) {}_{}^{N}{T}{}_{N - 1}^{V} ( {Ω}_{N - 1} - {}_{}^{N - 1}{T}{}_{L}^{V} {Ω}_{L} ) & [ 64 ] \\ = {C}_{{q}_{N}}^{T} {}_{}^{N}{T}{}_{N - 1}^{V} ( {Ω}_{N - 1} - {}_{}^{N - 1}{T}{}_{L}^{V} {Ω}_{L} ) & [ 65 ]\end{matrix}$$

After substitution in equation [59], one gets

Ω_{N}=C_{N}^{N}Tₙ₋₁^{V}(Ω_{N-1}−^{N-1}T_{L}^{V}Ω_{L})+^{N}T_{L}^{V}Ω_{L} [66]

with

C_{N}=I+E_{N}C_{q}_{_{N}}^{T} [67]

There is one more dependent co-ordinate to find. Substitution of [66] in [62] and premultiplying by ^{N}T_{C}^{F} results in

Ω_{N}=C*_{N}^{N}T_{N-1}^{V}(Ω_{N-1}−^{N-1}T_{L}^{V}Ω_{L})=0 [68]

with

C*_{N}=^{N}T_{C}^{F}C_{C}^{C}T_{N}^{V}C_{N}=Λ_{N}C_{N} [69]

which is a symmetrical matrix. Further calculations yield:

\dot{q}_{N-1}=C_{q}_{_{N−1}}^{TN-1}T_{N-2}^{V}(Ω_{N-2}−^{N-2}T_{L}^{V}Ω_{L}) [70]

Ω_{N-1}=C_{N-1}^{N-1}T_{N-2}^{V}(Ω_{N-2}−^{N-2}T_{L}^{V}Ω_{L})+^{N-1}T_{L}^{V}Ω_{L} [71]

with

C_{q}_{_{N−1}}^{T}=−(E_{N-1}^{TN-1}T_{N}^{F}C*_{N}^{N}T_{N-1}^{V}E_{N-1})⁻¹(E_{N-1}^{TN-1}T_{N}^{F}C*_{N}^{N}T_{N-1}^{V}) [72]

C_{N-1}=I+E_{N-1}C_{q}_{_{N−1}}^{T} [73]

The constraints matrices C* and C_{q}^{T} are found through a backward recursion step, the joint and spatial velocities through a forward recursion step. As soon as the spatial velocity Ω_{L} of the base of the loop is known, the dependent spatial velocities can be calculated.

A first part of the Hamiltonian equations of motion, i.e. \dot{p}=G(q,p,t), can be determined as follows, in a similar way as in example 1. The first independent body starting from the constraint is now N−2. One gets, by considering the bodies N, N−1 and N−2:

E_{N-2}^{T}(\dot{P}_{N-2}+Ω_{N-2}×P_{N-2}−T_{N-2})+E_{N-2}^{TN-2}T_{N-1}^{F}C_{N-1}^{T}(\dot{P}_{N-1}^{c}+Ω_{N}×P_{N-1}−T_{N-1}^{c})=0 [74]

which gives

\dot{P}_{N-2}^{c}+Ω_{N-2}×P_{N-2}^{c}=T_{N-2}^{c} [75]

Projection of equation [75] results in an expression for the time derivative of the conjugated canonical momentum, similar to equations [41] and [42]. The other loop bodies, till body L, are treated the same way as in the first example. In the constraint base body L, the reaction forces and torques due to the closing of the chain balance each other. From that body on, the chain can be treated as an open-loop system.

Determination of equations of motion part \dot{q}=F(q,p,t) can be performed in the same way as in previous example, thus allowing to obtain the second part of Hamiltonian equations. In this way, the full description of the system using a Hamiltonian formalism with recursive formulas is obtained.

It is an advantage of the embodiments of the present invention that no recursive step is necessary for the acceleration, as is necessary for the acceleration based procedures.

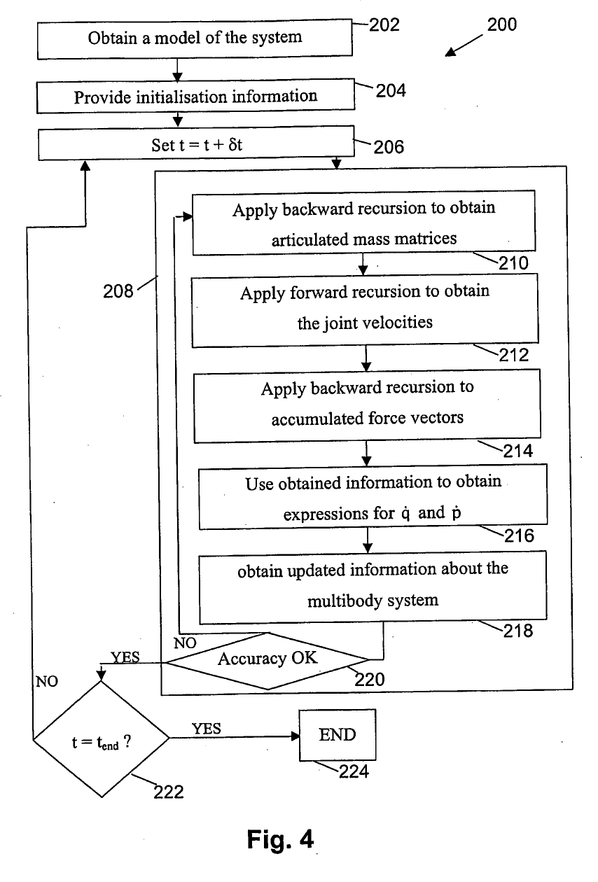

In a second aspect, the present invention relates to a method for determining motion, e.g. the dynamics of, of a constrained mechanical system. The mechanical system may be a multibody system. Determining the motion may be visualising, simulating, predicting the motion. The method comprises obtaining a model for the dynamics of the system e.g. by obtaining the equations of motion for the constrained multibody system and applying these equations of motion such that the dynamics of the constrained multibody system can be calculated over a certain time frame. The method is illustrated in FIG. 4, where the different steps of the method of the present embodiment are indicated. In the present embodiment, the definition of the physical and non-physical quantities represented in a symbolic way are similar as those provided in the first embodiment.

In a first step 202, a model for the dynamics of the system is obtained e.g. by obtaining the Hamiltonian formulation of the equations of motion, which express the time derivatives of the generalised co-ordinates and of the conjugated canonical momenta. These equations can be obtained for example by inputting the data using previously stored data or by calculating these equations using the method as described in the previous embodiment. The equations furthermore can be obtained immediately for the specific situation of the multibody system to be studied, or the equations can be obtained in a more general form, whereby specific non-dynamics oriented parameters characterising the multibody system still need to be supplied by the user. If equations are calculated at run time, first information is obtained of the topology of the system, the kind of joints, the mass, inertia and geometrical properties of the multibody system. Obtaining the equations of motion can be performed by loading pre-compiled equations of motion of the system or alternatively by setting up these equations at run-time. The exact method of how these equations are obtained is not limiting the present invention. These equations, as already described above, are given by

\dot{q}=F(q,p,t) [76]

\dot{p}=G(q,p,t) [77]

In a second step 204, the parameters needed to perform the calculations are provided. These parameters may e.g. comprise initial conditions of the system with amongst others the initial time t=tᵢ, and termination conditions, i.e. a time period Δt associated with the mechanical systems for which the calculations need to be performed. Other initial values, e.g. initial position, describing the known state of the system at the start of the calculation also may be provided. Other parameters that may be provided are the forces and torques that are applied on the system, such as e.g. gravity and actuation. Providing these parameters will allow determining the dynamics of the constrained mechanical multibody system.

In step 206, the time t is augmented with a time step δt such that in the following steps the calculation, based on the initial information or the information obtained in the previous cycle(s), can be obtained for a new time t. The time step δt used for calculating the forward dynamics is mainly determined by the specific application for which the calculations are performed, on the constrained mechanical multibody system that is described and on the computing power of the computer system used for performing these calculations. The time steps δt that can be used in the methods and systems of the present application can be at least the same as the time steps used in other types of calculations, but furthermore exceed this range, as the number of calculations needed is smaller than in other types of calculations, which allows a smaller time step for computing the same time period Δt in the same computing time. Alternatively, the time steps δt also may be larger than in other types of calculations as the degree of convergence in the calculation methods and systems of the present invention is larger than for other prior art systems. Method 200 then proceeds to step 208.

In step 208, the calculations are performed to obtain the dynamics of the constrained mechanical multibody system under study at time t. This step comprises different calculations, based on the obtained Hamiltonian equations of motion and on the definition of several quantities used to determine the Hamiltonian equations of motion. The results allow to obtain the parameters that completely characterise the constrained mechanical multibody system, based on a recursive formulation of the Hamiltonian equations of motion. The latter allows a high efficiency of the algorithms, allowing to reduce the amount of computing power needed. The method furthermore decreases the number of constraints violation errors. A possible way of calculating explicit values for the parameters characterising the constrained mechanical multibody system is shown in steps 210 to step 220, although the invention is not limited to this specific way of calculating.

In step 210, a backward recursive step is applied to obtain the constrained articulated mass matrices, which are needed to determine the joint velocities \dot{q}K. The latter is e.g. illustrated in example 1, equation [53], indicating that the constrained articulated mass matrix M_{K}^{c} is present in the formula for \dot{q}_{K}. The constrained articulated mass matrices can be found recursively, whereby the constrained articulated mass of the N^{th} body M_{N}^{c} is equal to the mass of the N^{th} body M_{N} and whereby the constrained articulated mass for the K^{th} body M_{K}^{c} is backward recursively found for K=N−1 to K=1 based on the constrained articulated mass of bodies with a higher identification number K. The equation describing the backward recursive determination of the constrained articulated mass matrices is given by equation [50].

In step 212, the time derivatives of the joint velocities \dot{q}_{K} are determined using a forward recursive step, as provided in step 202 by equations [76]. A practical example of the equations for obtaining \dot{q}_{K} is shown by equations [44] to [58] in example 1. The constrained articulated mass matrices present in these equations are determined in step 210. In this way, the time derivatives of the generalised co-ordinates, corresponding with the first part of the Hamiltonian equations of motion, are obtained.

In step 214, the constrained accumulated force vectors are determined using a backward recursive step. Examples of equations used for this backward recursive step are equations [43] as determined for example 1. In this way the constrained accumulated force vectors are obtained. The constrained accumulated force vectors require a separate recursion step as the constrained accumulated force vector is dependent on a momentum vector.

In step 216, the time derivatives of the canonical momenta conjugated to the generalised co-ordinates are determined using equation [77] as obtained in step 202. A practical illustration of these equations can be obtained from example 1, in equations [39] to [43]. Values for the constrained accumulated force vectors, present in equation [42], are introduced based on the calculations performed in step 214. In this way results are obtained corresponding with the second part of the Hamiltonian equations of motion.

In step 218, the parameters necessary to completely characterise the constrained mechanical multibody system at time t are determined over a number of cycles. This allows to obtain information for the constrained mechanical multibody system, e.g. about the path of the different bodies, about a possible impact or about the bodies being in contact or not. These results can be either stored or outputted or displayed immediately. The method may comprise visualising, predicting or simulating position related information of bodies of the constrained mechanical system. The obtained results typically are applied in the field of virtual prototyping, virtual reality, computer animation and avionics, although the invention is not limited to these applications. Virtual prototyping allows to simulate tests for prototype multibody systems, without the need for producing real prototype systems. The latter has major advantages as it reduces both the temporal cost and the financial cost. Some examples of applications in the field of virtual prototyping are performing dynamical simulations of a car on a road, studying alternative designs for cars, robots, etc., simulation of robot legs, predicting alternative behaviour upon change of a component or an environmental factor, etc. Another application is the determination of optimal mass compensation, i.e. active vibration, in e.g. a spacecraft. For virtual reality, the results of the calculations typically are read out quickly as there is the need to obtain real-time representation. Typical applications for virtual reality are games or systems that allow to feel the physical effects of what is simulated, such as the effect of being present in a moving object, such as a car. Applications also can be found in the field of computer animation, i.e. for visualising at least an approximation design of a physical system which is a multibody system. The latter is e.g. used for animation in games, e.g. displaying people running.

In decision step 220 it will be determined whether the accuracy and the stability of the system are sufficiently high or whether repetition of steps 210 to 218 is necessary. The numerical integrator running the recursive steps typically runs the recursive steps more than once to ensure the accuracy and stability. If the accuracy and stability are sufficiently high, method 200 proceeds to step 222. If not, steps 210 to 218 are repeated by the numerical integrator. Instead of applying a decision step 220 and thus providing a feedback loop, it is also possible to use a fixed number of runs of steps 210 to 218.

In decision step 222 it will be determined if further calculation of the forward dynamics of the constrained mechanical multibody system is necessary, i.e. if the full calculation of the forward dynamics of interest is already performed. If the current time equals an end time t_{end}, the calculations are ended and method 200 proceeds to ending step 224. The end time t_{end} may be a predetermined value or may depend on the degree of divergence of the calculations. Alternatively, the end time also may be determined by the occurrence of a specific event. If the end time has not been reached yet, method 200 proceeds to step 206 and a new calculation cycle is restarted after the time has been augmented with δt.

In a third aspect of the present invention, a method for using a set of equations of motion which allow to determine motion of a constrained multibody system is described, similar as to the first embodiment, but wherein an arbitrary selection of the dependent bodies is made. Determining motion thereby may be visualising, simulating or predicting the motion of a constrained multibody system, i.e. position related information about the different bodies of the constrained multibody system. Thus, whereas in the first embodiment, the dependent bodies were selected at the end of underlying open-loop structures, i.e. at the end of the open loop structures obtained by breaking up the structure, in the present embodiment a method allowing an arbitrary choice of selection of dependent bodies is provided. The latter may be advantageous for allowing avoiding singularity problems. It will be obvious for the person skilled in the art that the method as described in the first embodiment inherently is also described by the present embodiment. The latter also will be illustrated for the example of a planar chain, whereby equations of motion are determined for selection of the dependent bodies at the end of the underlying open-loop and for an arbitrary selection of the dependent bodies. An arbitrary selection of dependent/independent bodies may lead to a mix up of the recursive formulas for determining the equations of motion. If an arbitrary choice of independent coordinates is made, the dependent spatial velocities will not only be reduced to the inboard independent bodies, but will also influence outboard independent bodies thus messing up the recursive relationships. The dependent spatial velocities therefore cannot be automatically treated in the first backward recursion step. The recursive formulas therefore are obtained in a slightly different way.

As in the first embodiment, the method is based on obtaining a recursive formulation of a Hamiltonian form of the equations of motion of a constrained multibody system. The constraints may involve a closed loop multibody system. The symbolic representations of the physical and non-physical quantities have the same definition as provided in the previous embodiments. In other words, the transformation matrices ^{K}T_{K-1}^{V} and ^{K}T_{K-1}^{F} express how a spatial velocity vector respectively a spatial force vector changes from point to point, E refers to the joint matrix, Ω_{K} refers to the spatial velocity of body K, q_{K} refers to the relative velocity of the body K, C is the matrix representation of the constraints of the multibody system, P_{K} is the momentum vector of body K, M_{K} is the mass or mass matrix of body K, P_{K}* is the articulated momentum vector, P_{K}^{c} is the constrained articulated momentum vector, M^{c} is the constrained mass matrix, T_{K}^{c} is the constrained force vector for body K, p_{K} is the conjugated canonical momentum of body K, . . . . As described above the parent of a body K is indicated by Pa(K), whereas the children of a body K are indicated by Ch(K).

The general Hamiltonian form of the equations of motion can be expressed by time (t) derivatives of the generalised co-ordinates q and time derivatives of the conjugated canonical momenta p:

$$\{ \begin{matrix}\dot{q} = F ( q , p , t ) \\ \dot{p} = G ( q , p , t )\end{matrix} \qquad [ 5 ]$$

For a multibody system, each of the bodies will be described by an equation for the time derivatives of its generalised co-ordinates q and its conjugated canonical momentum p. The embodiments of the present invention provide a recursive formulation for the equations of motion such that the dynamics of a constrained mechanical system comprising multiple bodies can be calculated. In order to obtain the full equations of motion of the closed-loop system, three recursion steps are needed. The different steps that may be performed in order to obtain the equations of motion are equal to those as described in FIG. 1, described in more detail in the first embodiment. The difference is the possibility of an arbitrary selection of the dependent bodies. An explicit mathematical description of the method differs from the exemplary mathematical description provided for the first embodiment, as an arbitrary choice of independent coordinates will be reduced to both inboard and outboard independent bodies. An exemplary mathematical description of a possible way of deriving or obtaining the equations of motion is given in more detail in the following. It will be obvious for the person skilled in the art that the explicit algorithms for performing the steps of the method of the present embodiment of the invention are only given by way of illustration and that different algorithms for performing any or each step may be applied without leaving the scope of the invention.

First of all, it is to be noted that the new joint co-ordinates introduced by the loop closure can and will always be taken as dependent. The general expressions will be proved by induction, the equations related to the constraint joints acting as boundary conditions. The system can however have an arbitrary amount of bodies (n>2, there is no motion otherwise) and the two dependent bodies can be chosen arbitrarily as well.

The constraint equations can be obtained as follows. In a generic (constrained) multibody system, different forms of the constraint equations can be given recursively by

$$\begin{matrix}{C}_{K}^{*} ( {}_{}^{K}{T}{}_{Pa ( K )}^{V} {Ω}_{Pa ( K )} + {\sum }_{i ∈ iDes ( Pa ( K ) )} {}_{}^{K}{T}{}_{i}^{V} {E}_{i} {\dot{q}}_{i} ) = 0 \\ with \\ \begin{matrix}{C}_{qK}^{T} = 0 & ∀ K ∈ Ind\end{matrix} & [ 200 ] \\ \begin{matrix}{C}_{qK}^{T} = - {Λ}_{{j}_{K}}^{- 1} {E}_{K}^{T} {}_{}^{K}{T}{}_{Ch ( K )}^{F} {C}_{Ch ( K )}^{*} {}_{}^{Ch ( K )}{T}{}_{K}^{V} & ∀ K ∈ Dep\end{matrix} & [ 201 ] \\ {Λ}_{{j}_{K}} = {E}_{K}^{T} {Λ}_{{ }_{K}} {E}_{K} & [ 202 ] \\ {Λ}_{{ }_{K}} = {}_{}^{K}{T}{}_{Ch ( K )}^{F} {C}_{Ch ( K )} {}_{}^{Ch ( K )}{T}{}_{K}^{V} & [ 203 ] \\ {C}_{K} = I + {E}_{K} {C}_{{q}_{K}}^{T} & [ 204 ] \\ {C}_{K}^{*} = {}_{}^{K}{T}{}_{Ch ( K )}^{F} {C}_{Ch ( K )}^{*} {}_{}^{Ch ( K )}{T}{}_{K}^{V} {C}_{K} & [ 205 ]\end{matrix}$$

A constraint joint N+1 is always chosen as dependent, and therefore following boundary equations can be used

C*_{N+1}^{N+1}T_{Pa(N+1)}^{V}Ω_{Pa(N+1)}=0 [206]

with

C*_{N+1}=C_{N+1}=I−(E_{N+1}^{T}E_{N+1})⁻¹E_{N+1}^{TN+1}T_{Pa(N+1)}^{V}Ω_{Pa(N+1)} [207]

The generic relationships can be shown to be valid using an induction method. Presume the equations hold for body K. In that case they hold for the parent body L=Pa(K) as well. Indeed, decomposing the spatial velocity gives:

$${C}_{K}^{⋆} ( {}_{}^{K}{T}{}_{L}^{V} ( {}_{}^{L}{T}{}_{L - 1}^{V} {Ω}_{L - 1} + {E}_{L} {\dot{q}}_{L} ) + {\sum }_{i ∈ i Des ( L )} {}_{}^{K}{T}{}_{i}^{V} {E}_{i} {\dot{q}}_{i} ) = 0 \qquad [ 208 ]$$

In case L is an independent body, above equation can be reformulated by shifting the second term into the summation and premultiplying by ^{L}T_{K}^{F}.

$${C}_{L}^{⋆} {(}^{L} {T}_{L - 1}^{V} {Ω}_{L - 1} + {\sum }_{i ∈ i Des ( P a ( L ) )} {}_{}^{K}{T}{}_{i}^{V} {E}_{i} {\dot{q}}_{i} ) = 0 \qquad [ 209 ]$$

In case L is a dependent body, its joint velocities can be calculated explicitly premultiplying the equations by E_{L}^{TL}T_{K}^{F}

$${\dot{q}}_{L} = - {( {E}_{L}^{T} {}_{}^{L}{T}{}_{K}^{F} {C}_{K}^{⋆} {}_{}^{K}{T}{}_{L}^{V} {E}_{L} )}^{- 1} ( {E}_{L}^{T} {}_{}^{L}{T}{}_{K}^{F} {C}_{K}^{⋆} {}_{}^{C}{T}{}_{N}^{V} ( \begin{matrix}{}_{}^{K}{T}{}_{L - 1}^{V} {Ω}_{L - 1} + \\ {\sum }_{i ∈ i Des ( L )} {}_{}^{K}{T}{}_{i}^{V} {E}_{i} {\dot{q}}_{i}\end{matrix} ) ) \qquad [ 210 ]$$

Substitution in equation [208] ultimately results in the right expression. The canonical momenta conjugated to an independent body are given by

p_{K}=E_{K}^{T}P_{K}^{c} [211]

with the constrained articulated momentum vector

$$\begin{matrix}{P}_{K}^{c} = {P}_{K}^{⋆} + {\sum }_{i ∈ dep ( K )} {}_{}^{K}{T}{}_{i}^{F} {C}_{{q}_{i}}^{⋆} {E}_{i}^{T} {P}_{i}^{⋆} & [ 212 ] \\ = {P}_{K} + {\sum }_{i ∈ Ch ( K )} {}_{}^{K}{T}{}_{i}^{F} {P}_{i}^{c} & [ 213 ]\end{matrix}$$

wherein dep(K) is the set of all dependent bodies of body K.
Similar as in the first embodiment, the principle of virtual power will be used. The equations of motion can be obtained relatively easy. For the independent bodies K, one gets

\dot{p}_{K}=−E_{K}^{T}(Ω_{K}×P_{K}^{c})+E_{K}^{T}T_{K}^{c}+Ė_{K}^{T}P_{K}^{c} [214]

with

T_{K}^{c}=T_{K}+^{K}T_{Ch(K)}^{F}T_{Ch(K)}^{c} [215]

The constrained force vector of the leaf body N is

$${T}_{N}^{c} = {T}_{N} + {\sum }_{i ∈ dep} [ \begin{matrix}{}_{}^{N}{T}{}_{i}^{F} {C}_{{q}_{i}}^{⋆} {E}_{i}^{T} {T}_{i}^{⋆} + \\ {}_{}^{N}{T}{}_{i}^{F} [ \begin{matrix}{\dot{C}}_{{q}_{i}}^{⋆} {E}_{i}^{T} + ( {Ω}_{i} \times I ) {C}_{{q}_{i}}^{⋆} {E}_{i}^{T} - \\ {C}_{{q}_{i}}^{⋆} {E}_{i}^{T} ( {Ω}_{i} \times I )\end{matrix} ] {P}_{i}^{⋆}\end{matrix} ] \qquad [ 216 ]$$

For the leaf body N, one gets:

$$\begin{matrix}{\dot{q}}_{N} = {M}_{{j}_{N}}^{- 1} ( {p}_{N} - {E}_{N}^{T} {M}_{N} {}_{}^{N}{T}{}_{P a ( N )}^{V} {Ω}_{P a ( N )} - {E}_{N}^{T} {\sum }_{i ∈ dep} {}_{}^{N}{T}{}_{i}^{F} {C}_{{q}_{i}}^{⋆} {p}_{i} ) & [ 217 ] \\ {P}_{N}^{c} = {M}_{N}^{′} {}_{}^{N}{T}{}_{P a ( N )}^{V} {Ω}_{P a ( N )} + {D}_{N}^{′} + {\sum }_{i ∈ dep} {D}_{N}^{{p}_{i}^{′}} {p}_{i} & [ 218 ] \\ {D}_{N}^{{p}_{i}^{′}} = ( I - {M}_{N} {E}_{N} {M}_{{j}_{N}}^{- 1} {E}_{N}^{T} ) {}_{}^{N}{T}{}_{i}^{F} {C}_{{q}_{i}}^{⋆} ( i ∈ dep ) & [ 219 ] \\ with & \\ {D}_{K}^{′} = {M}_{K}^{⋆} {E}_{K} {M}_{{j}_{K}}^{⋆ - 1} ( {p}_{K} - {E}_{K}^{T} {D}_{K} ) + {D}_{K} & \\ and & \\ {D}_{K} = {\sum }_{i ∈ Ch ( K )} {}_{}^{K}{T}{}_{i}^{F} {D}_{i}^{′} & \end{matrix}$$

The boundary condition is D_{N}=0. Hence, one gets for body N:

D′_{N}=M*_{N}E_{N}M*_{jN}⁻¹p_{N}

If body N is dependent, D^{p′}^{_{N}} takes the following form

D_{N}^{p}^{_{N}}^{′}=(I−M_{N}E_{N}Mⱼ_{_{N}}⁻¹E_{N}^{T})^{N}T_{N}^{F}C*_{q}_{_{N}}+M_{N}E_{N}Mⱼ_{_{N}}⁻¹ [220]

The expressions for all the other bodies K up till the first encountered dependent body are:

$$\begin{matrix}{\dot{q}}_{K} = {M}_{{j}_{K}}^{- {1}^{⋆}} ( \begin{matrix}{p}_{K} + {E}_{K}^{T} {\sum }_{i ∈ dep} ( {}_{}^{K}{T}{}_{i}^{F} {C}_{{q}_{i}}^{⋆} {p}_{i} - {D}_{K}^{{p}_{i}} {p}_{i} ) - \\ {E}_{K}^{T} {D}_{K} - {E}_{K}^{T} {M}_{K}^{⋆} {}_{}^{K}{T}{}_{P a ( K )}^{V} {Ω}_{P a ( K )}\end{matrix} ) & [ 221 ] \\ {P}_{K}^{c} = {M}_{K}^{⋆} {Ω}_{K} + {D}_{K} + {\sum }_{i ∈ dep} {D}_{K}^{{p}_{i}} {P}_{i} & [ 222 ] \\ {D}_{K}^{{p}_{i}} = {}_{}^{K}{T}{}_{Ch ( K )}^{F} {D}_{Ch ( K )}^{{p}_{i}^{′}} ( i ∈ dep ) & [ 223 ] \\ {D}_{K}^{{p}_{i}^{′}} = ( I - {M}_{K}^{⋆} {E}_{K} {M}_{{j}_{K}}^{⋆ - 1} {E}_{K}^{T} ) {D}_{K}^{{p}_{i}} + {M}_{K}^{⋆} {E}_{K} {M}_{{j}_{K}}^{⋆ - 1} {}_{}^{K}{T}{}_{i}^{F} {E}_{i}^{T} {C}_{{q}_{i}}^{⋆} & [ 224 ]\end{matrix}$$

If K is dependent, one gets:

D_{K}^{p}^{_{K}}^{′}=(I−M*_{K}E_{K}M*ⱼ_{_{K}}⁻¹E_{K}^{T})D_{K}^{p}^{_{K}}+M*_{K}E_{K}M*ⱼ_{_{K}}⁻¹(I+E_{K}^{T}C*_{q}_{_{K}}) [225]

D′_{K}=(I−M*_{K}E_{K}M*ⱼ_{_{K}}⁻¹E_{K}^{T})D_{K} [226]

As soon as the first dependent body is encountered, i.e. the first from the base, the velocities can be propagated forward till the joint constraint. The expressions for the joint and spatial velocities of the first dependent body A are

$$\begin{matrix}{\dot{q}}_{A} = {\dot{q}}_{A}^{′} + {\sum }_{i ∈ dep} {\dot{q}}_{A}^{{p}_{i}} {p}_{i} + {\dot{q}}_{A}^{{Ω}_{P a ( A )}} {Ω}_{P a ( A )} & [ 227 ] \\ {\dot{q}}_{A}^{′} = - {M}_{{j}_{A}}^{* - 1} {E}_{A}^{T} {D}_{A} & [ 228 ] \\ {\dot{q}}_{A}^{{p}_{i}} = {M}_{{j}_{A}}^{* - 1} ( {{E}_{A}^{T}}^{A} {T}_{i}^{F} {C}_{{q}_{i}}^{*} - {E}_{A}^{T} {D}_{A}^{{p}_{i}} ) & [ 229 ] \\ {\dot{q}}_{A}^{{p}_{A}} = {M}_{{j}_{A}}^{* - 1} ( I + {E}_{A}^{T} {C}_{{q}_{A}}^{*} - {E}_{A}^{T} {D}_{A}^{{p}_{A}} ) & [ 230 ] \\ {\dot{q}}_{A}^{{Ω}_{P a ( A )}} = - {M}_{{j}_{A}}^{* - 1} {E}_{A }^{T} {{M}_{A}^{*}}^{A} {T}_{P a ( A )}^{V} & [ 231 ] \\ {Ω}_{A} {=}^{A} {t}_{P a ( A )}^{v} {Ω}_{P a ( A )} + {E}_{A} {\dot{q}}_{A} & [ 232 ] \\ = {Ω}_{A}^{′} + {\sum }_{i ∈ dep} {Ω}_{A}^{{p}_{i}} {p}_{i} + {Ω}_{A}^{{Ω}_{P a ( A )}} {Ω}_{P a ( A )} & [ 233 ] \\ {Ω}_{A}^{′} = {E}_{A} {\dot{q}}_{A}^{′} & [ 234 ] \\ {Ω}_{A}^{{p}_{i}} = {E}_{A} {\dot{q}}_{A}^{{p}_{i}} & [ 235 ] \\ {Ω}_{A}^{{Ω}_{P a ( A )}} = {E}_{A} {\dot{q}}_{A}^{{Ω}_{P a ( A )}} {+}^{A} {T}_{P a ( A )}^{V} & [ 236 ]\end{matrix}$$

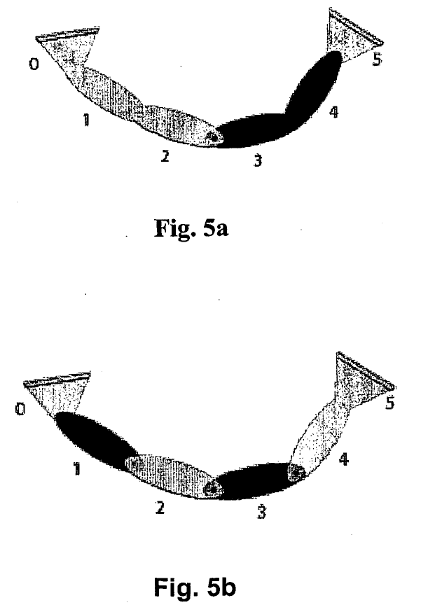

This propagation can be continued till the joint constraint is reached. Then, the constraint equation can be used to find the dependent canonical momenta. With this information, the recursion process can be restarted.
The above describes the determination of the equations of motion for an arbitrary selection of independent, and consequently dependent, bodies and co-ordinates.
During the dynamic simulation of a generic multibody system, singularities might occur. Mathematically, the singularities manifest themselves typically during the calculation of the C_{q}-matrix. This matrix requires the inversion of another matrix that is not always regular. If a singularity occurs, the set of independent co-ordinates is not valid and should be changed. It is interesting to note that a singularity can de detected quickly during the first backward recursion.
In order to illustrate the above described method for determining a set of equations of motion, the above described exemplary mathematical description will be applied to the example of a planar chain with both ends fixed to the ground by means of pin-joints. There are four joint co-ordinates but only two degrees of freedom. Joint 5 is chosen to be the constraint joint. Removing it produces the underlying open-loop structure. Both the method whereby the dependent co-ordinates are selected at the end of an underlying open-loop structure, i.e. example 3 illustrated in FIG. 5a, and the method whereby the dependent co-ordinates are selected more arbitrary, i.e. example 4 illustrated In FIG. 5b, are described.

### Example 3

In the third example, the method of the present embodiment is illustrated for a planar chain with both ends fixed as described in FIG. 5a. The last two bodies, i.e. body 3 and body 4, are considered as dependent, illustrating that the method as described in the present embodiment also covers the occurrence of dependent coordinates at the end of an underlying open-loop structure, as described in the first embodiment.
Writing the principle of virtual power for the whole system yields

$${\sum }_{i = 1}^{4} [ {Ω}_{i}^{* T} ( {\dot{P}}_{i} + Ω \times {P}_{i} - {T}_{i} ) ] = 0 \qquad [ 237 ]$$

The major difference with an open-loop case is that the virtual joint velocities \dot{q}*ᵢ are not independent to each other. It is to be observed that the spatial velocities of the last two dependent bodies are known if the spatial velocity of body 2 is given. The details of the motion of body 1 does indeed not matter and it will be shown that the spatial velocities Ω₃ and Ω₄ can be expressed as functions of spatial velocity Ω₂.
This will enable to write the principle of virtual power as

$${\sum }_{i = 1}^{2} [ {\dot{q}}_{i}^{* T} {E}_{i}^{T} ( {\dot{P}}_{i}^{c} + {Ω}_{i} \times {P}_{i}^{c} - {T}_{i}^{c} ) ] = 0 \qquad [ 238 ]$$

with P^{c} and T^{c} the so-called constrained articulated momentum vector and the constrained force vector. Only the independent virtual joint velocities, i.e. \dot{q}₁ and \dot{q}₂, are present in the equations, they can thus be treated just like open-loop structures and the equations degenerate into the following two simple equations:

E₁^{T}(\dot{P}₁^{c}+Ω₁×P₁^{c}−T₁^{c})=0 [239]

E₂^{T}(\dot{P}₂^{c}+Ω₂×P₂^{c}−T₂^{c})=0 [240]

In order to reduce the dependent spatial velocities Ω₃ and Ω₄, one starts with the first form of the constraint equations:

Ω₅=0 [241]

Reference frame 5 as shown in FIG. 5a represents the ground at the loop closure. It has an associated (dependent) constraint joint q₅ that will be used as intermediate quantity. It is to be noted that the above expression of the constraint equations are redundant: there are six equations for only two constraints. The decomposition of the spatial velocity gives

Ω₅=⁵T₄^{V}Ω₄+E₅\dot{q}₅=0 [242]

After projection on the subspace E₅, an expression for the joint velocity of body 5 is obtained

\dot{q}₅=−(E₅^{T}E₅)⁻¹E₅^{T5}T₄^{V}Ω₄=C_{q}_{₅}^{T5}T₄^{V}Ω₄ [243]

The matrix E₅^{T}E₅ can always be inversed, this justifies the choice of q₅ as permanent dependent coordinates. Substitution of equation [242] in [243] results in

C₅⁵T₄^{V}Ω₄=0 [244]

with

C₅=I+E₅C_{q}_{₅}^{T} [245]

Matrix C is called the constraint matrix. Equation [244] typically is called the second form of the constraint equations. Using equations [242] and [243], the spatial velocity of body 5, i.e. in fact the ground can be reduced to the spatial velocity of body 4:

Ω₅=C₅^{T5}T₄^{V}Ω₄ [246]

One can now start with the second form of the constraint equations and repeat the procedure to continue the reduction towards the independent bodies. Premultiplying equation [244] by E₄^{T4}T₅^{F} and decomposing spatial velocity Ω₄ results in

$$\begin{matrix}{\dot{q}}_{4} = - {( {E}_{4}^{T} {T}_{5}^{F} {C}_{5}^{5} {T}_{4}^{V} {E}_{4} )}^{- 1} {( {{E}_{4}^{T}}^{4} {T}_{5}^{F} {C}_{5}^{5} {T}_{4}^{V} )}^{4} {T}_{3}^{V} {Ω}_{3} \\ = {{C}_{{q}_{4}}^{T}}^{4} {T}_{3}^{V} {Ω}_{3}\end{matrix} \qquad \begin{matrix}[ 247 ] \\ [ 248 ]\end{matrix}$$

Note that matrix (E₄^{T4}T₅^{F}C₅⁵T₄^{V}E₄) needs to be regular. Singularity would be the consequence of a bad partitioning in independent and dependent coordinates. Ω₄ can now be found as

Ω₄=⁴T₃^{V}Ω₃+E₄\dot{q}₄=C₄⁴T₃^{V}Ω₃ [249]

with

C₄=I+E₄C_{q}_{₄}^{T} [250]

The third form of the constraint equations can also readily be derived by substitution of [249] in [244] and premultiplication by ⁴T₅^{F}:

$$\begin{matrix}{{C}_{4}^{*}}^{4} {T}_{3}^{V} {Ω}_{3} = 0 \\ with & [ 251 ] \\ {C}_{4}^{*} = {}_{}^{4}{T}{}_{5}^{F} {C}_{5}^{5} {T}_{4}^{V} {C}_{4} & [ 252 ] \\ = {Λ}_{4} {C}_{4} & [ 253 ]\end{matrix}$$

whish is a symmetrical matrix. The procedure can be repeated once more to attain the first independent body 2. This leads to following expressions:

\dot{q}₃=C_{q}_{₃}^{T3}T₂^{V}Ω₂ [254]

Ω₃=C₃³T₂^{V}Ω₂ [255]

with

C_{q}_{₃}^{T}=−(E₃^{T3}T₄^{F}C*₄⁴T₃^{V}E₃)⁻¹(E₃^{T3}T₄^{F}C*₄⁴T₃^{V}) [256]

C₃=I+E₃C_{q}_{₃}^{T} [257]

The constraints matrices C* and C_{q}^{T} are found during a backward recursion step, the joint and spatial velocities during a forward recursion step. Note that CC=C,
This means it is a projection operator. Note also that CE=0, so C lies in the subspace orthogonal to the space E of virtual motion. Remember that the objective of the velocity reductions was to eliminate the dependent virtual spatial velocities from the principle of virtual power. This can now be achieved, as the dependent velocities can be written as

Ω₃=C₃³T₂^{V}Ω₂ [258]

Ω₄=C₄T₃^{V}C₃³T₂^{V}Ω₂ [259]

Before getting back to the principle of virtual power, it is necessary to take a closer look at the canonical momenta associated with the independent coordinates. It is important to realize that no canonical momenta exist for the dependent coordinates, canonical momenta are only defined for the independent coordinates.

$$\begin{matrix}\begin{matrix}{p}_{2} = \frac{\partial L}{\partial {\dot{q}}_{2}} \\ = \frac{\partial T}{\partial {\dot{q}}_{2}} \\ = {\sum }_{i = 1}^{4} \frac{\partial {Ω}_{i}^{T}}{\partial {\dot{q}}_{2}} {P}_{i}\end{matrix} & [ 260 ] \\ = {E}_{2}^{T} {P}_{2} + {E}_{2}^{2} {T}_{3}^{F} {C}_{3}^{T} {P}_{3} + {E}_{2}^{2} {T}_{3}^{F} {C}_{3}^{T} {T}_{4}^{F} {C}_{4}^{T} {P}_{4} & [ 261 ]\end{matrix}$$

The constrained articulated momentum vector of a body is defined as

$${P}_{K}^{c} = {P}_{K}^{*} + {\sum }_{i ∈ dep} {}_{}^{K}{T}{}_{}^{F} {C}_{{q}_{i}}^{*} {E}_{i}^{T} {P}_{i}^{*} \qquad [ 262 ]$$

The canonical momenta associated to body 2 become

p₂=E₂^{T}P₂^{c} [263]

The reader may easily verify that the vectors C_{q}* for the dependent bodies 3 and 4 are given by

C*_{q}_{₃}=C_{q}_{₃} [264]

C*_{q}_{₄}=C_{q}_{₄}+⁴T₃^{F}C*_{q}_{₃}E₃^{T3}T₄^{F}C_{q}_{₄} [265]

The constrained momentum vectors for all bodies other than body 4 can also be found using following recursive relationship:

P_{K}^{c}=P_{K}+^{K}T_{K+1}P_{K+1}^{c} [266]

Similarly, one can readily find the canonical momenta for body 1:

p₁=E₁^{T}P₁^{c} [267]

Using the velocity reductions introduced in previous section, the principle of virtual power can be written as

$${\sum }_{i = 1}^{4} [ {Ω}_{i}^{* T} ( {\dot{P}}_{i} + {Ω}_{i} \times {P}_{i} - {T}_{i} ) ] = {\sum }_{i = 1}^{2} {\dot{q}}_{i}^{* T} {A}_{i} = 0 \qquad [ 268 ]$$

Coefficient A₂ can be easily identified as

$$\begin{matrix}{A}_{2} = {\sum }_{i = 1}^{4} [ \frac{\partial {Ω}_{i}^{* T}}{\partial {\dot{q}}_{2}^{*}} ( {\dot{P}}_{i} + {Ω}_{i} \times {P}_{i} - {T}_{i} ) ] & [ 269 ] \\ \begin{matrix} = {E}_{2}^{T} ( {\dot{P}}_{2} + {Ω}_{2} \times {P}_{2} - {T}_{2} ) + \\ {{E}_{2}^{T}}^{2} {T}_{3}^{F} {C}_{3}^{T} ( {\dot{P}}_{3} + {Ω}_{3} \times {P}_{3} - {T}_{3} ) + \\ {{E}_{2}^{T}}^{2} {T}_{3}^{F} {{C}_{3}^{T}}^{3} {T}_{4}^{F} {C}_{4}^{T} ( {\dot{P}}_{4} + {Ω}_{4} \times {P}_{4} - {T}_{4} ) \\ = 0\end{matrix} & [ 270 ]\end{matrix}$$

One can recognize the same structure as in [260], which is not surprising, as the coefficients in both expressions arise from ∂Ωᵢ^{T}/∂\dot{q}_{K}. This allows to use the same recursive relationships to write A₂ in terms of P₂^{c}. The terms of [269] associated with P₄^{c} can be grouped and written as:

$$\begin{matrix}{\dot{P}}_{4} + {Ω}_{4} \times {P}_{4} - {T}_{4} {+}^{4} {T}_{3}^{F} {C}_{{q}_{3}}^{*} {E}_{3}^{T} ( {\dot{P}}_{3}^{*} + {Ω}_{3} \times {P}_{3}^{*} - {T}_{3}^{*} ) + {C}_{{q}_{4}}^{*} {E}_{4}^{T} ( {\dot{P}}_{4} + {Ω}_{4} \times {P}_{4} - {T}_{4} ) = {\dot{P}}_{4}^{c} + {Ω}_{4} \times {P}_{4}^{c} - {T}_{4}^{c} \\ with & [ 271 ] \\ {T}_{4}^{c} = {T}_{4} + {}_{}^{4}{T}{}_{3}^{F} {C}_{{q}_{3}}^{*} {E}_{3}^{T} {T}_{3}^{*} + {C}_{{q}_{4}}^{*} {E}_{4}^{T} {T}_{4} + {}_{}^{4}{T}{}_{3}^{F} [ \begin{matrix}{\dot{C}}_{q 3}^{*} {E}_{3}^{T} + ( {Ω}_{3} \times I ) {C}_{{q}_{3}}^{*} {E}_{3}^{T} - \\ {C}_{{q}_{3}}^{*} {E}_{3}^{T} ( {Ω}_{3} \times I )\end{matrix} ] {P}_{3}^{*} + [ \begin{matrix}{\dot{C}}_{q 3}^{*} {E}_{4}^{T} + ( {Ω}_{4} \times I ) {C}_{{q}_{4}}^{*} {E}_{4}^{T} - \\ {C}_{{q}_{4}}^{*} {E}_{4}^{T} ( {Ω}_{4} \times I )\end{matrix} ] {P}_{4} & [ 272 ]\end{matrix}$$

As one can see, the constrained force vector associated with the leaf body is quite involved. This is obviously the price to pay for adding constraints. Fortunately, the expressions are much simpler for the remaining bodies. Grouping the terms associated with P₃^{c} gives

\dot{P}₃+Ω₃×P₃−T₃+³T₄^{F}(\dot{P}₄^{c}+Ω₄×P₄^{c}−T₄^{c})=\dot{P}₃^{c}+Ω₃×P₃^{c}−T₃^{c} [273]

with

T₃^{c}=T₃+³T₄^{F}T₄^{c} [274]

Finally, the expression for A₂ can be found as

$$\begin{matrix}\begin{matrix}{A}_{2} = {E}_{2}^{T} ⌊ {\dot{P}}_{2} + {Ω}_{2} \times {P}_{2} - {T}_{2} + {}_{}^{2}{T}{}_{3}^{F} {C}_{3}^{T} ( {\dot{P}}_{3}^{c} + {Ω}_{3} \times {P}_{3}^{c} - {T}_{3}^{c} ) ⌋ \\ = {E}_{2}^{T} ( {\dot{P}}_{2}^{c} + {Ω}_{2} \times {P}_{2}^{c} - {T}_{2}^{c} )\end{matrix} \\ with & [ 275 ] \\ {T}_{2}^{c} = {T}_{2} + {}_{}^{2}{T}{}_{3}^{F} {T}_{3}^{c} & [ 276 ]\end{matrix}$$

Hence, A₂=0 can be transformed into

\dot{p}₂=E₂^{T}(T₂^{c}−Ω₂×P₂^{c})+Ė₂^{T}P₂^{c} [277]

Similarly for articulated body 1:

\dot{p}₁=E₁^{T}(T₁^{c}−Ω₁×P₁^{c})+Ė₁^{T}P₁^{c} [278]

with

T₁^{c}=T₁+¹T₂^{F}T₂^{c} [279]

The independent coordinate velocities are needed to obtain the remaining Hamiltonian equations. The dependent coordinate velocities \dot{q}₃, \dot{q}₄ and \dot{q}₅ were already calculated. To find joint velocity \dot{q}₂, the projection of the constrained momentum vector on the joint axis is needed.

p₂=E₂^{T}P₂^{c}=E₂^{T}(P₂+²T₃^{F}P₃^{c}) [280]

The constrained momentum vector of body 3 can be written as (see [260])

$$\begin{matrix}{P}_{3}^{c} = {C}_{3}^{T} ( {P}_{3} + {}_{}^{3}{T}{}_{4}^{T} {C}_{4}^{T} {P}_{4} ) & [ 281 ] \\ = {C}_{3}^{T} ( {M}_{3} + {}_{}^{3}{T}{}_{4}^{F} {C}_{4}^{T} {M}_{4} {C}_{4}^{4} {T}_{3}^{V} ) {Ω}_{3} & [ 282 ] \\ = {M}_{3}^{c} {T}_{2}^{V} {Ω}_{2} & [ 283 ] \\ {M}_{3}^{c} = {C}_{3}^{T} ( {M}_{3} + {}_{}^{3}{T}{}_{4}^{F} {C}_{4}^{T} {M}_{4} {C}_{4}^{4} {T}_{3}^{V} ) {C}_{3} & [ 284 ]\end{matrix}$$

M₃^{c} being the constrained mass matrix. For body 2, one subsequently gets:

$$\begin{matrix}{P}_{2}^{c} = ( {M}_{2} + {}_{}^{2}{T}{}_{4}^{F} {M}_{3}^{c} {}_{}^{3}{T}{}_{2}^{V} ) {C}_{3} & [ 285 ] \\ = {M}_{2}^{c} {Ω}_{2} & [ 286 ] \\ {M}_{2}^{c} = {M}_{2} + {}_{}^{2}{T}{}_{3}^{F} {{M}_{3}^{c}}^{3} {T}_{2}^{V} & [ 287 ]\end{matrix}$$

The joint velocity \dot{q}₂ can easily be derived from above equations:

$$\begin{matrix}{p}_{2} = {E}_{2}^{T} {P}_{2}^{c} = {E}_{2}^{T} {M}_{2}^{c} ( {}_{}^{2}{T}{}_{1}^{V} {Ω}_{1} + {E}_{2} {\dot{q}}_{2} ) & [ 288 ] \\ {\dot{q}}_{2} = {( {E}_{2}^{T} {M}_{2}^{c} {E}_{2} )}^{- 1} ( {p}_{2} - {E}_{2}^{T} {M}_{2}^{c} {}_{}^{2}{T}{}_{1}^{V} {Ω}_{1} ) & [ 289 ] \\ = {M}_{{j}_{2}}^{c} {}^{- 1} ( {p}_{2} - {E}_{2}^{T} {M}_{3}^{c} {}_{}^{2}{T}{}_{1}^{V} {Ω}_{1} ) & [ 290 ]\end{matrix}$$

To obtain the joint velocity for body 1, one can substitute above equation in the expression for the constrained momentum vector [285]:

$$\begin{matrix}{P}_{2}^{c} = {M}_{2}^{c} ( {}_{}^{2}{T}{}_{1}^{V} {Ω}_{1} + {E}_{2} {\dot{q}}_{2} ) & [ 291 ] \\ = {M}_{N - 2}^{c} [ {}_{}^{2}{T}{}_{1}^{V} {Ω}_{1} + {E}_{2} {M}_{{j}_{2}}^{{c}^{- 1}} ( {p}_{2} - {E}_{2}^{T} {M}_{2}^{c} {}_{}^{2}{T}{}_{1}^{V} {Ω}_{1} ) ] & [ 292 ] \\ = {M}_{n - 2}^{′} {}_{}^{2}{T}{}_{1}^{V} {Ω}_{1} + {D}_{2}^{′} & [ 293 ] \\ {M}_{2}^{′} = {M}_{2}^{c} - {M}_{2}^{c} {E}_{2} {M}_{{j}_{2}}^{{c}^{- 1}} {E}_{2}^{T} {M}_{2}^{c} & [ 294 ] \\ {D}_{2}^{′} = {M}_{2}^{c} {E}_{2} {M}_{{j}_{2}}^{{c}^{- 1}} {p}_{2} & [ 295 ]\end{matrix}$$

Repeating previous procedure gives:

$$\begin{matrix}{P}_{1}^{c} = {P}_{1} + {}_{}^{1}{T}{}_{2}^{F} {P}_{2}^{c} & [ 296 ] \\ = ( {M}_{1} + {}_{}^{1}{T}{}_{2}^{F} {M}_{2}^{′} {}_{}^{2}{T}{}_{1}^{V} ) {Ω}_{1} + {}_{}^{1}{T}{}_{2}^{F} {D}_{2}^{′} & [ 297 ] \\ = {M}_{1}^{c} {Ω}_{1} + {D}_{1} & [ 298 ] \\ {M}_{1}^{c} = {M}_{1} + {}_{}^{1}{T}{}_{2}^{F} {M}_{2}^{′} {}_{}^{2}{T}{}_{1}^{V} & [ 299 ] \\ {D}_{1} = {}_{}^{1}{T}{}_{2}^{F} {D}_{2}^{′} & [ 300 ]\end{matrix}$$

The joint velocity is then:

$$\begin{matrix}\begin{matrix}{p}_{1} = {E}_{1}^{T} {P}_{1}^{c} \\ = {E}_{1}^{T} {M}_{1}^{c} {E}_{1} {\dot{q}}_{1} + {E}_{1}^{T} {D}_{1}\end{matrix} & [ 301 ] \\ {\dot{q}}_{1} = {( {E}_{1}^{T} {M}_{1}^{c} {E}_{1} )}^{- 1} ( {p}_{1} - {E}_{1}^{T} {D}_{1} ) & [ 302 ] \\ = {M}_{{j}_{1}}^{{c}^{- 1}} ( {p}_{1} - {d}_{1} ) & [ 303 ]\end{matrix}$$

The method is very similar to the one designed for open-loop systems. It is recursive and of O(n). It still comprises the 3 typical recursion sweeps: a backward recursion for computing the inertia properties, remainder momentums and constraint matrices, followed by a forward recursion to solve the velocities and the constrained momentum vectors. And finally a last backward recursion to calculated the constrained force vectors.

### Example 4

In the fourth example, the method of the present embodiment is illustrated for a planar chain with both ends fixed as described in FIG. 5b. Bodies 1 and 3 are chosen as dependent, thus illustrating application of the method as described in the present embodiment for an arbitrary choice of dependent bodies. The specific selection of independent coordinates in previous example had one important consequence: the dependent spatial velocities could be reduced to the inboard independent bodies, and could therefore be treated in the first backward recursion step. If an arbitrary choice of independent coordinates is made, the dependent spatial velocities will influence outboard independent bodies as well, messing up the recursive relationships. This will become clear with this example.
First reduction of the dependent spatial velocities will be performed, starting with expressing the constraint equations. The first and second forms of the constraint equations remain unchanged in comparison to the previous example, but the third form becomes

C*₄(⁴T₃^{V}Ω₃+E₄\dot{q}₄)=0 [304]

with

C*₄=⁴T₅^{V}C₅⁵T₄^{V} [306]

Joint velocity \dot{q}₄ is independent and should not be written as function of other velocities, but stay explicitly in the equations instead. The fourth form of the constraint equations involves a dependent joint velocity, which can be eliminated as before resulting in

\dot{q}₃=C_{q}_{₃}^{T}(³T₂^{V}Ω₂+³T₄^{V}E₄\dot{q}₄) [307]

C*₃(³T₂^{V}Ω₂+³T₄^{V}E₄\dot{q}₄)=0 [308]

with

C_{q}_{₃}^{T}=−(E₃^{T3}T₄^{F}C*₄⁴T₃^{V}E₃)⁻¹(E₃^{T3}T₄^{F}C*₄⁴T₃^{V}) [309]

C₃=I+E₃C_{q}_{₃}^{T} [310]

C*₃=³T₄^{F}C*₄⁴T₃^{V}C₃ [311]

The next form of the constraint equations is again a function of an independent velocity:

C*₂(²T₁^{V}Ω₁+E₂\dot{q}₂+²T₄^{V}E₄\dot{q}₄)=0 [312]

with

C*₂=²T₃^{F}C*₃³T₂^{V} [313]

Finally, equations [312] can be further developed into the last form

C*₁(¹T₂^{V}E₂\dot{q}₂+¹T₄^{V}E₄\dot{q}₄)=0 [314]

with

C_{q}_{₁}^{T}=−(E₁^{T1}T₂^{F}C*₂²T₁^{V}E₁)⁻¹E₁^{T1}T₂^{F}C*₂²T₁^{V} [315]

C₁=I+E₁C_{q}_{₁}^{T} [316]

C*₁=¹T₂^{F}C*₂²T₁^{V}C₁ [317]

In summary, the reduction of the dependent spatial velocities yields:

Ω₃=C₃³T₂^{V}Ω₂+E₃C_{q}_{₃}^{T3}T₄^{V}E₄\dot{q}₄ [318]

Ω₁=E₁C_{q}_{₁}^{T}(¹T₂^{V}E₂\dot{q}₂+¹T₄^{V}E₄\dot{q}₄ [319]

These velocities have nearly the same expression as in previous example, except for the additional terms comprising the (outboard) independent joint velocities. The expressions for the constraint matrices are also very similar. They can still be calculated during the first backward recursion step.
Using the definition of the canonical momenta for independent body 4, one obtains:

$$\begin{matrix}{P}_{4} = {\sum }_{i = 1}^{4} \frac{\partial {Ω}_{i}^{T}}{\partial {\dot{q}}_{4}} {P}_{i} & [ 320 ] \\ = {E}_{4}^{T} {}_{}^{4}{T}{}_{1}^{F} {C}_{{q}_{1}} {E}_{1}^{T} {P}_{1} + {E}_{4}^{T} {}_{}^{4}{T}{}_{1}^{F} {C}_{{q}_{1}} {E}_{1}^{T} {}_{}^{1}{T}{}_{2}^{F} {P}_{2} + {E}_{4}^{T} {}_{}^{4}{T}{}_{3}^{F} {C}_{{q}_{3}} {E}_{3}^{T} {P}_{3} + {E}_{4}^{T} {}_{}^{4}{T}{}_{1}^{F} {C}_{{q}_{1}} {E}_{1}^{T} {}_{}^{1}{T}{}_{3}^{F} {P}_{3} + {E}_{4}^{T} {P}_{4} + {E}_{4}^{T} {}_{}^{4}{T}{}_{3}^{F} {C}_{{q}_{3}} {E}_{3}^{T} {}_{}^{3}{T}{}_{4}^{F} {P}_{4} + {E}_{4}^{T} {}_{}^{4}{T}{}_{1}^{F} {C}_{{q}_{1}} {E}_{1}^{T} {}_{}^{1}{T}{}_{3}^{F} {C}_{3}^{T} {}_{}^{3}{T}{}_{4}^{F} {P}_{4} & [ 321 ] \\ = + {E}_{4}^{T} ( {P}_{4} + {}_{}^{4}{T}{}_{1}^{F} {C}_{{q}_{1}}^{*} {E}_{1}^{T} {P}_{1}^{*} + {}_{}^{4}{T}{}_{3}^{F} {C}_{{q}_{3}}^{*} {E}_{3}^{T} {P}_{3}^{*} ) & [ 322 ] \\ = {E}_{4}^{T} {P}_{4}^{c} \\ with & [ 323 ] \\ {C}_{{q}_{1}}^{*} = {C}_{{q}_{1}} & [ 324 ] \\ {C}_{{q}_{3}}^{*} = {C}_{{q}_{3}} + {}_{}^{3}{T}{}_{1}^{F} {C}_{{q}_{1}}^{*} {E}_{1}^{T} {}_{}^{1}{T}{}_{3}^{F} {C}_{{q}_{3}} & [ 325 ]\end{matrix}$$

Similarly, the canonical momenta associated with body 2 are

p₂=E₂^{T}P₂^{c} [326]

wherein

P₂^{c}=P*₂+²T₁^{F}C*_{q}_{₁}E₁^{T}P*₁+²T₃^{F}C*_{q}_{₃}E₃^{T}P*₃ [327]

The constrained articulated momentum vectors are now dependent on inboard and outboard bodies, and can thus not be calculated in one sweep. On the other hand, one can observe that the projections of the dependent articulated momenta are used. The quantities E₁^{T}P*₁ and E₃^{T}P*₃ could be interpreted as dependent canonical momenta p₁ and p₃, although they cannot be obtained from the Lagrangian function. The constrained momentum vectors have the same recursive relationship as in the previous example:

P_{K}^{c}=P_{K}+^{K}T_{K+1}^{F}P_{K+1}^{c} [328]

but now with

P₄^{c}=P₄+⁴T₁^{F}C*_{q}_{₁}E₁^{T}P*₁+⁴T₃^{F}C*_{q}_{₃}E₃^{T}P*₃ [329]

as boundary condition.
The principle of virtual power can be used as previously:

$${\sum }_{i = 1}^{4} {Ω}_{i}^{* T} ( {\dot{P}}_{i} + {Ω}_{i} \times {P}_{i} - {T}_{i} ) = {\dot{q}}_{2}^{* T} {A}_{2} + {\dot{q}}_{4}^{* T} {A}_{4} = 0 \qquad [ 330 ]$$

The coefficient A₄ is

$$\begin{matrix}\begin{matrix} {A}_{4} = {\sum }_{i = 1}^{4} [ \frac{\partial }{\partial {\dot{q}}_{4}^{*}} ( {\dot{P}}_{i} + {Ω}_{i} \times {P}_{i} - {T}_{i} ) ] \\ = {E}_{4}^{T} ( {\dot{P}}_{4}^{c} + {Ω}_{4} \times {P}_{4}^{c} - {T}_{4}^{c} ) = 0\end{matrix} \\ with & [ 331 ] \\ {T}_{4}^{c} = {T}_{4} + {}_{}^{4}{T}{}_{1}^{F} {C}_{{q}_{1}}^{*} {E}_{1}^{T} {T}_{1}^{*} + {}_{}^{4}{T}{}_{3}^{F} {C}_{{q}_{3}}^{*} {E}_{3}^{T} {T}_{3}^{*} + {}_{}^{4}{T}{}_{1}^{F} [ \begin{matrix}{\dot{C}}_{{q}_{1}}^{*} {E}_{1}^{T} + ( {Ω}_{1} \times I ) {C}_{{q}_{1}}^{*} {E}_{1}^{T} - \\ {C}_{{q}_{1}}^{*} {E}_{1}^{T} ( {Ω}_{1} \times I )\end{matrix} ] {P}_{1}^{*} + {}_{}^{4}{T}{}_{3}^{F} [ \begin{matrix}{\dot{C}}_{{q}_{3}}^{*} {E}_{3}^{T} + ( {Ω}_{3} \times I ) {C}_{{q}_{3}}^{*} {E}_{3}^{T} - \\ {C}_{{q}_{3}}^{*} {E}_{3}^{T} ( {Ω}_{3} \times I )\end{matrix} ] {P}_{3}^{*} & [ 332 ] \\ = {T}_{4} + {}_{}^{4}{T}{}_{1}^{F} {T}_{1}^{c} + {}_{}^{4}{T}{}_{3}^{F} {T}_{3}^{c} & [ 333 ]\end{matrix}$$

Projection on the joint subspace results in

\dot{p}₄=−E₄^{T}(Ω₄×P₄^{c}−T₄^{c}) [334]

The equations of motion associated to independent body 2 are easily found as

\dot{p}₂=−E₂^{T}(Ω₂×P₂^{c}−T₂^{c}) [335]

### Joint Velocities

Finding the joint velocities becomes more complex when arbitrary independent coordinates are chosen. The velocities can be expressed as functions of the known independent canonical momenta a priori unknown dependent canonical momenta however. These dependent canonical momenta can then be found using the constraint equations, whereafter the velocities can be calculated explicitly. The procedure starts with leaf independent body 4:

$$\begin{matrix}{P}_{4}^{c} = {P}_{4} + {}_{}^{4}{T}{}_{1}^{F} {C}_{{q}_{1}}^{*} {E}_{1}^{T} {P}_{1}^{*} + {}_{}^{4}{T}{}_{3}^{F} {C}_{{q}_{3}}^{*} {E}_{3}^{T} {P}_{3}^{*} & [ 336 ] \\ = {M}_{4} ( {}_{}^{4}{T}{}_{3}^{V} {Ω}_{3} + {E}_{4} {\dot{q}}_{4} ) + {}_{}^{4}{T}{}_{1}^{F} {C}_{{q}_{1}}^{*} {p}_{1} + {}_{}^{4}{T}{}_{3}^{F} {C}_{{q}_{3}}^{*} {p}_{3} & [ 337 ] \\ ⇒ {\dot{q}}_{4} = {M}_{{j}_{4}}^{- 1} ( \begin{matrix}{p}_{4} - {E}_{4}^{T} {M}_{4} {}_{}^{4}{T}{}_{3}^{V} {Ω}_{3} - \\ {E}_{4}^{T} {}_{}^{4}{T}{}_{1}^{F} {C}_{{q}_{1}}^{*} {p}_{1} - {E}_{4}^{T} {}_{}^{4}{T}{}_{3}^{F} {C}_{{q}_{3}}^{*} {p}_{3}\end{matrix} ) & [ 338 ]\end{matrix}$$

Substituting equation [338] in [337] gives

P₄^{c}=M′₄⁴T₃^{V}Ω₃+D′₄+D₄^{p}^{₁}^{′}p₁+D ₄^{p}^{₃}^{′}p₃ [339]

D₄^{p}^{₁}^{′}=(I−M₄E₄Mⱼ_{₄}⁻¹E₄^{T})⁴Tᵢ^{F}C*_{q}_{ᵢ} (i=1, 3) [340]

Observe the similarity with remainder term D^{σ′} obtained in the augmented Lagrangian approach. The reduced mass matrix M′ and the remainder momentum vector D′ have the same definition as for open-loop systems. The constrained momentum vector of body 3 can be developed as

$$\begin{matrix}{P}_{3}^{c} = {P}_{3} + {}_{}^{3}{T}{}_{4}^{F} {P}_{4}^{c} & [ 341 ] \\ = {M}_{3}^{*} {Ω}_{3} + {D}_{3} + {D}_{3}^{{p}_{1}} {p}_{1} + {D}_{3}^{{p}_{3}} {p}_{3} & [ 342 ] \\ {D}_{3}^{{p}_{i}} = {}_{}^{3}{T}{}_{4}^{F} {D}_{4}^{{p}_{i}^{′}} ( i = 1 , 3 ) & [ 343 ]\end{matrix}$$

Take a closer look at the projection of the constrained momentum vector on the motion subspace

$$\begin{matrix}{E}_{3}^{T} {P}_{3}^{c} = {E}_{3}^{T} ( {P}_{3}^{*} + {}_{}^{3}{T}{}_{1}^{F} {C}_{{q}_{1}}^{*} {p}_{1} + {C}_{{q}_{3}}^{*} {p}_{3} ) & [ 344 ] \\ = {p}_{3} + {E}_{3}^{T} {}_{}^{3}{T}{}_{1}^{F} {C}_{{q}_{1}}^{*} {p}_{1} + {E}_{3}^{T} {C}_{{q}_{3}}^{*} {p}_{3} & [ 345 ]\end{matrix}$$

Hence, it can be expressed in terms of the dependent canonical momenta solely. Combination of equations [342] and [345] leads to

$$\begin{matrix}{\dot{q}}_{3} = {M}_{{j}_{3}}^{- {1}^{*}} ( \begin{matrix}{p}_{3}^{′} + {E}_{3}^{T} {}_{}^{3}{T}{}_{1}^{F} {C}_{{q}_{1}}^{*} {p}_{1} + {E}_{3}^{T} {C}_{{q}_{3}}^{*} {p}_{3} - {E}_{3}^{T} {D}_{3} - \\ {E}_{3}^{T} {D}_{3}^{{p}_{1}} {p}_{1} - {E}_{3}^{T} {D}_{3}^{{p}_{3}} {p}_{3} - {E}_{3}^{T} {M}_{3}^{*} {}_{}^{3}{T}{}_{2}^{V} {Ω}_{2}\end{matrix} ) \\ and & [ 346 ] \\ {P}_{3}^{c} = {M}_{3}^{′} {}_{}^{3}{T}{}_{2}^{V} {Ω}_{2} + {D}_{3}^{′} + {D}_{3}^{{p}_{{1}^{′}}} {p}_{1} + {D}_{3}^{{p}_{{3}^{′}}} {p}_{3} \\ with & [ 347 ] \\ {D}_{3}^{{p}_{{3}^{′}}} = ( I - {M}_{3}^{*} {E}_{3} {M}_{{j}_{3}}^{* - 1} {E}_{3}^{T} ) {D}_{3}^{{p}_{3}} + {M}_{3}^{*} {E}_{3} {M}_{{j}_{3}}^{* - 1} ( I + {E}_{3}^{T} {C}_{{q}_{3}}^{*} ) & [ 348 ] \\ {D}_{3}^{{p}_{{1}^{′}}} = ( I - {M}_{3}^{*} {E}_{3} {M}_{{j}_{3}}^{* - 1} {E}_{3}^{T} ) {D}_{3}^{{p}_{1}} + {M}_{3}^{*} {E}_{3} {M}_{{j}_{3}}^{* - 1} {}_{}^{3}{T}{}_{1}^{F} {E}_{1}^{T} {C}_{{q}_{1}}^{*} & [ 349 ] \\ {D}_{3}^{′} = ( I - {M}_{3}^{*} {E}_{3} {M}_{{j}_{3}}^{* - 1} {E}_{3}^{T} ) {D}_{3} & [ 350 ]\end{matrix}$$

The contribution of the dependent canonical momenta p₃ is not taken into D₃, as in open-loop systems. The expression of the latter is thus slightly different. The next body 2 was chosen to be an independent one. The recursion process is carried on:

$$\begin{matrix}\begin{matrix}{P}_{2}^{c} = {P}_{2} + {}_{}^{2}{T}{}_{3}^{F} {P}_{3}^{c} \\ = {M}_{2}^{*} {Ω}_{2} + {D}_{2} + {D}_{2}^{{p}_{1}} {p}_{1} + {D}_{2}^{{p}_{3}} {p}_{3}\end{matrix} & [ 351 ] \\ = {M}_{2}^{′} {}_{}^{2}{T}{}_{1}^{V} {Ω}_{1} + {D}_{1}^{′} + {D}_{1}^{{p}_{{1}^{′}}} {p}_{1} + {D}_{1}^{{p}_{{3}^{′}}} {p}_{3} & [ 352 ]\end{matrix}$$

And finally:

P₁^{c}=P₁+¹T₂^{F}P₂^{c}=M*₁Ω₁+D₁+D₁^{p}^{₁}p₁+D₁^{p}^{₃}p₃ [353]

Just like for the other dependent body 3, one can calculate the projection of the constrained momentum vector on the joint subspace to obtain

E₁^{T}P₁^{c}=p₁+E₁^{T}C*_{q}_{₁}p₁+E₁^{T1}T₃^{F}C*_{q}_{₃}p₃ [354]

The joint velocity of the first body can now be written as

$${\dot{q}}_{1} = {M}_{{j}_{1}}^{- {1}^{*}} ( \begin{matrix}{p}_{1} + {E}_{1}^{T} {}_{}^{1}{T}{}_{3}^{F} {C}_{q 3}^{*} {p}_{3} + {E}_{1}^{T} {C}_{{q}_{1}}^{*} {p}_{1} - \\ {E}_{1}^{T} {D}_{1} - {E}_{1}^{T} {D}_{1}^{{p}_{1}} {p}_{1} - {E}_{1}^{T} {D}_{1}^{{p}_{3}} {p}_{3}\end{matrix} ) \qquad [ 355 ]$$

The next part of the procedure is to propagate the velocities from the base to the tip. At that point the constraint equations can be used to solve for the dependent canonical momenta. With knowledge of these momenta, all quantities can be calculated explicitly in a last sweep. So, the joint velocity of body 1 can be written formally as

\dot{q}₁=\dot{q}′₁+\dot{q}₁^{p}^{₁}p₁+\dot{q}₁^{p}^{₃}p₃ [356]

The spatial velocity becomes

Ω₁=E₁\dot{q}₁=Ω′₁+Ω₁^{p}^{₁}p₁+Ω₁^{p}^{₃}p₃ [357]

The same applies for all other spatial velocities, in particular for body 4:

Ω₄=⁴T₃^{V}Ω₃+E₄\dot{q}₄=Ω′₄+Ω₄^{p}^{₁}p₁+Ω₄^{p}^{₃}p₃ [358]

Substitution in the second form of the constraint equations yields

C₅⁵T₄^{V}(Ω₄^{p}^{₁}p₁+Ω₄^{p}^{₃}p₃)=−C₅⁵T₄^{V}Ω′₄ [359]

This can be solved for the dependent canonical momenta:

$$( \begin{matrix}{p}_{1} \\ {p}_{3}\end{matrix} ) = - {[ ( \begin{matrix}{Ω}_{4}^{{p}_{1}^{T}} \\ {Ω}_{4}^{{p}_{3}^{T}}\end{matrix} ) {}_{}^{4}{T}{}_{5}^{F} {C}_{5} {}_{}^{5}{T}{}_{4}^{V} ( {Ω}_{4}^{{p}_{1}} {Ω}_{4}^{{p}_{3}} ) ]}^{- 1} ( \begin{matrix}{Ω}_{4}^{{p}_{1}^{T}} \\ {Ω}_{4}^{{p}_{3}^{T}}\end{matrix} ) {C}_{5} {}_{}^{5}{T}{}_{4}^{V} {Ω}_{4}^{′} \qquad [ 360 ]$$

The inverted matrix has dimension 2×2.

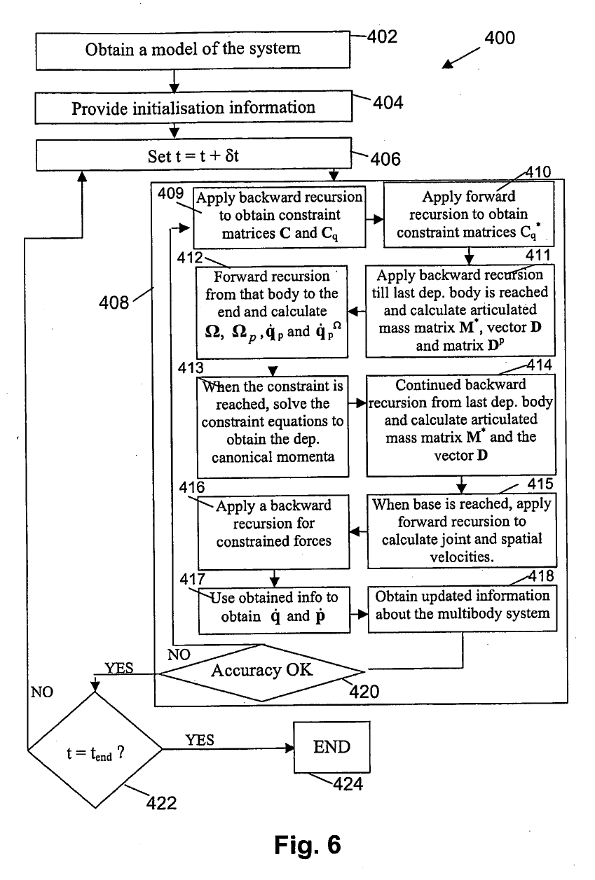

In a fourth aspect, the present invention relates to a method for determining the motion, e.g. dynamics, of a constrained mechanical system, such as e.g. a multibody system, similar to the method as described in the second aspect, whereby the equations of motion for the constrained multibody system are determined based on an arbitrary selection of the dependent bodies, as described in the third aspect of the present invention. Determining the motion thereby may be visualising, predicting or simulating the motion. The method also may comprise visualising, predicting or simulating position related information of bodies of the constrained mechanical system. The method comprises obtaining a model for the dynamics of the system e.g. by obtaining the equations of motion for the constrained multibody system, determined based on an arbitrary selection of the dependent bodies in the multibody system, and applying these equations of motion such that the dynamics of the constrained multibody system can be calculated over a certain time frame. The method comprises a number of steps similar to the method as described in the second aspect, but an arbitrary selection of dependent bodies in the constrained multibody system mixes up the recursive steps, thus leading to a different number of calculations to obtain the dynamics of the constrained mechanical multibody system under study at time t. The method 400 is illustrated in FIG. 6, where the different steps of the method 400 of the present embodiment are indicated.

In a first step 402, a model for the dynamics of the system is obtained e.g. by obtaining the Hamiltonian formulation of the equations of motion, which express the time derivatives of the generalised co-ordinates and of the conjugated canonical momenta. These equations can be obtained for example by inputting the data using previously stored data or by calculating these equations using the method as described in the previous embodiment. The equations furthermore can be obtained immediately for the specific situation of the multibody system to be studied, or the equations can be obtained in a more general form, whereby specific non-dynamics oriented parameters characterising the multibody system still need to be supplied by the user. The equations may be based on an arbitrary selection of the dependent bodies of the constrained multibody system, i.e. they do not need to be restricted to selection of dependent bodies at the end of underlying open-loop structures. When the equations are calculated at run time, first information is obtained of the topology of the system, the kind of joints, the mass, inertia and geometrical properties of the multibody system. Obtaining the equations of motion can be performed by loading pre-compiled equations of motion of the system or alternatively by setting up these equations at run-time. The exact method of how these equations are obtained is not limiting the present invention. These equations, as already described above, are given by

\dot{q}=F(q,p,t) [76]

and

\dot{p}=G(q,p,t) [77]

In a second step 404, the parameters needed to perform the calculations are provided. These parameters may e.g. comprise initial conditions of the system with amongst others the initial time t=tᵢ, and termination conditions, i.e. a time period Δt associated with the mechanical systems for which the calculations need to be performed. Other initial values, e.g. initial position, describing the known state of the system at the start of the calculation also may be provided. Other parameters that may be provided are the forces and torques that are applied on the system, such as e.g. gravity and actuation. Providing these parameters will allow determining the dynamics of the constrained mechanical multibody system.

In step 406, the time t is augmented with a time step δt such that in the following steps the calculation, based on the initial information or the information obtained in the previous cycle(s), can be obtained for a new time t. The time step δt used for calculating the forward dynamics is mainly determined by the specific application for which the calculations are performed, on the constrained mechanical multibody system that is described and on the computing power of the computer system used for performing these calculations. The time steps δt that can be used in the methods and systems of the present application can be at least the same as the time steps used in other types of calculations, but furthermore exceed this range, as the number of calculations needed is smaller than in other types of calculations, which allows a smaller time step for computing the same time period Δt in the same computing time. Alternatively, the time steps δt also may be larger than in other types of calculations as the degree of convergence in the calculation methods and systems of the present invention is larger than for other prior art systems. Method 400 then proceeds to step 408.

In step 408, the calculations are performed to obtain the dynamics of the constrained mechanical multibody system under study at time t. This step comprises different calculations, based on the obtained Hamiltonian equations of motion, obtained for arbitrary selection of the dependent bodies in the multi-body system, and on the definition of several quantities used to determine the Hamiltonian equations of motion. The results allow to obtain the parameters that completely characterise the constrained mechanical multibody system, based on a recursive formulation of the Hamiltonian equations of motion. The latter allows a high efficiency of the algorithms, allowing to reduce the amount of computing power needed. The method furthermore decreases the number of constraints violation errors. A possible way of calculating explicit values for the parameters characterising the constrained mechanical multibody system is shown in steps 409 to step 420, although the invention is not limited to this specific way of calculating.

In step 409 the constraint matrices C and C_{q} are calculated in a backward recursive step. In step 410, a forward recursive step is used for calculating the constraint matrix C*_{q}. In other words, for arbitrary selection of the dependent body typically both a backward and a forward recursive step are required. The articulated mass matrix M* and the vectors D and Dₚ are then calculated in a backward recursion step until the last dependent body is reached, in step 411. In step 412, when the last dependent body is met in step 411, a forward recursion is started from that body to the end and Ω, Ωₚ, \dot{q}ₚ, \dot{q}ₚ^{Ω}, are calculated. When the constraint is reached, the constraint equations are solved in step 413 in order to obtain the dependent canonical momenta. The latter is not a recursive procedure. In step 414, from the last dependent body onwards, i.e. where the recursion was reversed in step 412, the original backward recursive step performed in step 411 is continued and articulated mass matrix M* and the vectors D are calculated. Dₚ is not calculated anymore because the dependent canonical momenta are already known. In step 415, when the base is reached, a forward recursive step is performed to calculate the joint and spatial velocities, whereafter in step 416 the constrained forces are obtained using a last backward recursion.

In step 417, the parameters necessary to completely characterise the constrained mechanical multibody system at time t are determined over a number of cycles. This allows to obtain information for the constrained mechanical multibody system, e.g. about the path of the different bodies, about a possible impact or about the bodies being in contact or not. These results can be either stored or outputted or displayed immediately. The method may comprise visualising, predicting or simulating position related information of bodies of the constrained mechanical system. The obtained results typically are applied in the field of virtual prototyping, virtual reality, computer animation and avionics, although the invention is not limited to these applications. Virtual prototyping allows to simulate tests for prototype multibody systems, without the need for producing real prototype systems. The latter has major advantages as it reduces both the temporal cost and the financial cost. Some examples of applications in the field of virtual prototyping are performing dynamical simulations of a car on a road, studying alternative designs for cars, robots, etc., simulation of robot legs, predicting alternative behaviour upon change of a component or an environmental factor, etc. Another application is the determination of optimal mass compensation, i.e. active vibration, in e.g. a spacecraft. For virtual reality, the results of the calculations typically are read out quickly as there is the need to obtain real-time representation. Typical applications for virtual reality are games or systems that allow to feel the physical effects of what is simulated, such as the effect of being present in a moving object, such as a car. Applications also can be found in the field of computer animation, i.e. for visualising at least an approximation design of a physical system which is a multibody system. The latter is e.g. used for animation in games, e.g. displaying people running.

In decision step 420 it will be determined whether the accuracy and the stability of the system are sufficiently high or whether repetition of steps 409 to 418 is necessary. The numerical integrator running the recursive steps typically runs the recursive steps more than once to ensure the accuracy and stability. If the accuracy and stability are sufficiently high, method 400 proceeds to step 422. If not, steps 409 to 418 are repeated by the numerical integrator. Instead of applying a decision step 420 and thus providing a feedback loop, it is also possible to use a fixed number of runs of steps 409 to 418.

In decision step 422 it will be determined if further calculation of the forward dynamics of the constrained mechanical multibody system is necessary, i.e. if the full calculation of the forward dynamics of interest is already performed. If the current time equals an end time t_{end}, the calculations are ended and method 400 proceeds to ending step 424. The end time t_{end} may be a predetermined value or may depend on the degree of divergence of the calculations. Alternatively, the end time also may be determined by the occurrence of a specific event. If the end time has not been reached yet, method 400 proceeds to step 406 and a new calculation cycle is restarted after the time has been augmented with δt.

The method of using the equations of motion of a constrained mechanical system, such as e.g. a multi-body system essentially differs from the method as described in the second aspect of the present invention by the need for both a backward and forward recursive step to obtain the constraint matrices, these recursions not being complete recursions but only sweeping till the last dependent body and by the need for reversion of the first backward recursive step when the last dependent body is met in order to solve the constraint equations thus leading to the dependent canonical momenta.

It is an advantage of the above described embodiments that the equations of motion for a constrained mechanical system can be obtained using recursive formula's, resulting in an efficient system. In the above described embodiments, the constrained articulated momentum vector is used for obtaining a set of equations of motions based on the Hamiltonian formalism which are suitable for recursive calculations. The latter allows to obtain an efficient method for determining, simulating, visualising or predicting the motion of a constrained mechanical system.

In a fifth aspect, the invention also relates to a system for determining the motion of a constrained mechanical system comprising multiple bodies. The system thus is adjusted for performing the method as described in the second embodiment of the present invention. The motion is determined over a number of time steps δt such that the dynamics of the system over a time period Δt is obtained. The system comprises a computing system that is adjusted with a means for obtaining at least data related to a set of Hamiltonian equations of motion for the constrained mechanical multibody system under study and a means for computing at least position related information of the multiple bodies of the constrained mechanical system over a time period Δt. The means for obtaining at least data related to a set of Hamiltonian equations of motion may also comprise means for receiving data about the initial state of the mechanical multibody system and about the termination conditions for the calculation. The means for computing performs these calculations for an initial time tᵢ and for subsequent times t obtained by adding a time step δt to the initial time tᵢ. The time step does not need to be constant but can be adjusted e.g. depending on the density of information needed during different parts of the time period Δt. The system may be coupled to or may incorporated a means for visualizing the obtained results. The system furthermore may predict the further motion of a constrained mechanical system based on calculations according to the methods as described above. The system therefore may include a means for predicting motion of a constrained mechanical system. The system may be any type of computer system having significant computing power to obtain the calculations within a reasonable time and may e.g. be a personal computer, a number of computers grouped in a network, a mainframe, etc. and the calculations may be performed subsequently one task after the other in a single processor or may be performed in parallel, i.e. using distributed processing over a number of processors. For the latter, the different calculations of the method can be divided over the processors such that the necessary information needed by specific processors is always available at these processors or so that the

In a fifth aspect, the invention also relates to a system for determining the motion of a constrained mechanical system comprising multiple bodies. The system thus is adjusted for performing the method as described in the second embodiment of the present invention. The motion is determined over a number of time steps δt such that the dynamics of the system over a time period Δt is obtained. The system comprises a computing system that is adjusted with a means for obtaining at least data related to a set of Hamiltonian equations of motion for the constrained mechanical multibody system under study and a means for computing at least position related information of the multiple bodies of the constrained mechanical system over a time period Δt. The means for obtaining at least data related to a set of Hamiltonian equations of motion may also comprise means for receiving data about the initial state of the mechanical multibody system and about the termination conditions for the calculation. The means for computing performs these calculations for an initial time tᵢ and for subsequent times t obtained by adding a time step δt to the initial time tᵢ. The time step does not need to be constant but can be adjusted e.g. depending on the density of information needed during different parts of the time period Δt. The system may be coupled to or may incorporated a means for visualizing the obtained results. The system furthermore may predict the further motion of a constrained mechanical system based on calculations according to the methods as described above. The system therefore may include a means for predicting motion of a constrained mechanical system. The system may be any type of computer system having significant computing power to obtain the calculations within a reasonable time and may e.g. be a personal computer, a number of computers grouped in a network, a mainframe, etc. and the calculations may be performed subsequently one task after the other in a single processor or may be performed in parallel, i.e. using distributed processing over a number of processors. For the latter, the different calculations of the method can be divided over the processors such that the necessary information needed by specific processors is always available at these processors or so that the processors are instructed to wait with further processing until the needed information has arrived.

In accordance with the above described embodiments, the present invention also includes a computer program product which provides the functionality of any of the methods according to the present invention when executed on a computing system. Further, the present invention includes a data carrier such as a CD-ROM or a diskette which stores the computer product in a machine readable form and which executes at least one of the methods of the invention when executed on a computing device. Nowadays, such software is often offered on the Internet, hence the present invention includes transmitting the computer product according to the present invention over a local or wide area network.

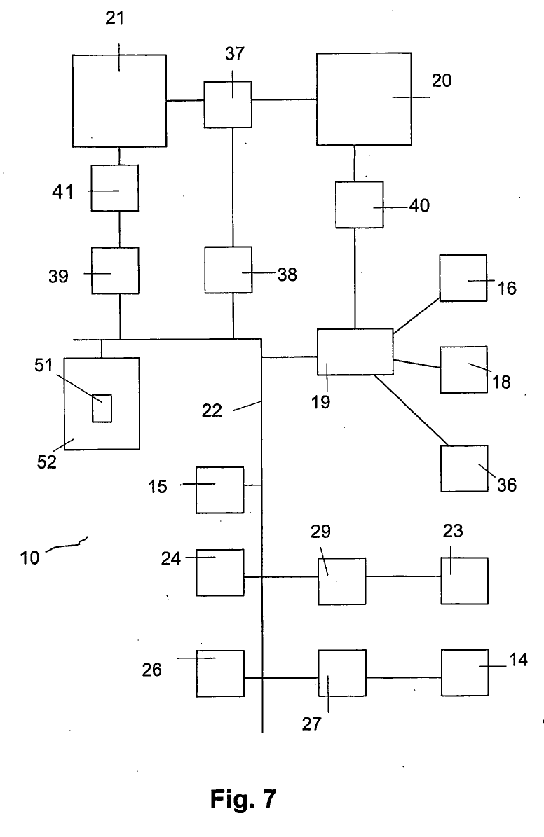

FIG. 7 is a schematic representation of a computing system which can be utilized with the methods and in a system according to the present invention. A computer 10 is depicted which may include a video display terminal 14, a data input means such as a keyboard 16, and a graphic user interface indicating means such as a mouse 18. Computer 10 may be implemented as a general purpose computer, e.g. a UNIX workstation or a personal computer.

Computer 10 includes a Central Processing Unit (“CPU”) 15, such as a conventional microprocessor of which a Pentium IV processor supplied by Intel Corp. USA is only an example, and a number of other units interconnected via system bus 22. The computer 10 includes at least one memory. Memory may include any of a variety of data storage devices known to the skilled person such as random-access memory (“RAM”), read-only memory (“ROM”), non-volatile read/write memory such as a hard disc as known to the skilled person. For example, computer 10 may further include random-access memory (“RAM”) 24, read-only memory (“ROM”) 26, as well as an optional display adapter 27 for connecting system bus 22 to the optional video display terminal 14, and an optional input/output (I/O) adapter 29 for connecting peripheral devices (e.g., disk and tape drives 23) to system bus 22. Video display terminal 14 can be the visual output of computer 10, which can be any suitable display device such as a CRT-based video display well-known in the art of computer hardware. However, with a portable or notebook-based computer, video display terminal 14 can be replaced with a LCD-based or a gas plasma-based flat-panel display. Computer 10 further includes user interface adapter 19 for connecting a keyboard 16, mouse 18, optional speaker 36, as well as allowing optional inputs from an external system 20. The inputs can be, for example physical value inputs from physical value capture devices such as sensors 40 attached to a robot which send information about the position of a multibody system comprised in the physical system 20. The sensors 40 may be any suitable sensors for capturing physical parameters of system 20.

System 20 may also be a remote control device, e.g. located on earth whereas computer system 10 is located in a multibody system, e.g. in a transport vehicle/robot on a planet. Due to the delay between earth and the planet the robot cannot be controlled in real time. In such a situation, computer programs running on computer system 10 implement methods in accordance with the present invention to simulate or predict the behaviors of the multibody system. This can be used to control the multibody system in real time safely in between receiving commands from earth.

Additionally or alternative actuators 41 may be provided for an additional or alternative physical system 21 which may also be connected to bus 22 via a communication adapter 39 connecting computer 10 to a data network such as the Internet, an Intranet a Local or Wide Area network (LAN or WAN) or a CAN. This allows transmission of commands from computer system 10 over a telecommunications network, from a near location to a remote location, e.g. via the Internet or a radio connection, to the remote system 21. For example, the sensors 40 may pick up states of the system 20 which are input to computer system 10. Using methods in accordance with any of the methods of the present invention, computer system 10 predicts the behavior of system 20 and sends commands to actuators 41 in system 21 to modify this behavior. An example, could be vibration sensing using sensors 40 and commands for active damping being provided to actuators 41 of a shakers in system 21 to neutralize the vibration; The calculation of the commands to be sent to the actuators computer system 10 uses methods of the present invention to predict the behavior of system 20 when acted on by the actuators of system 21.

The terms “physical value capture device” or “sensor” includes devices which provide values of parameters of a physical system to be simulated. The sensors may include devices for transmitting details of evolving physical systems. The present invention also includes within its scope that the relevant physical values are input directly into the computer using the keyboard 16 or from storage devices such as 23.

A parameter control unit 37 of system 20 and/or 21 may also be connected via a communications adapter 38. Parameter control unit 37 may receive an output value from computer 10 running a computer program in accordance with the present invention or a value representing or derived from such an output value and may be adapted to alter a parameter of physical system 20 and/or system 21 in response to receipt of the output value from computer 10.

Computer 10 also may include a graphical user interface that resides within machine-readable media to direct the operation of computer 10. Any suitable machine-readable media may retain the graphical user interface, such as a random access memory (RAM) 24, a read-only memory (ROM) 26, a magnetic diskette, magnetic tape, or optical disk (the last three being located in disk and tape drives 23). Any suitable operating system and associated graphical user interface (e.g., Microsoft Windows) may direct CPU 15. In addition, computer 10 includes a control program 51 which resides within computer memory storage 52. Control program 51 contains instructions that when executed on CPU 15 carry out the operations described with respect to any of the methods of the present invention.

In other embodiments computer system 10 can be used to visualize (on display unit 14) predicted or simulated behaviors of a physical system using any of the methods of the present invention. Physical system 20 and/or 21 with the relevant connections may constitute a simulator in which persons can experience a simulated behavior of a multibody system, in which actions of the persons, e.g. via a joy stick result in predicted changes of the multibody system. These changes can be displayed on the display unit 14 and commands may be sent to actuators 41 to move the simulator in the predicted way. This gives a real-life effect to the person in the simulator as is generally known to the skilled person of large scale simulators.

Those skilled in the art will appreciate that the hardware represented in FIG. 7 may vary for specific applications. For example, other peripheral devices such as optical disk media, audio adapters, or chip programming devices, such as PAL or EPROM programming devices well-known in the art of computer hardware, and the like may be utilized in addition to or in place of the hardware already described.

In the example depicted in FIG. 7, the computer program product (i.e. control program 51) can reside in computer storage 52. However, it is important that while the present invention has been, and will continue to be, described accordingly, those skilled in the art will appreciate that the mechanisms of the present invention are capable of being distributed as a program product in a variety of forms, and that the present invention applies equally regardless of the particular type of signal bearing media used to actually carry out the distribution. Examples of computer readable signal bearing media include: recordable type media such as floppy disks and CD ROMs and transmission type media such as digital and analogue communication links.

Other arrangements for accomplishing the objectives of the method and system for simulating the motion of a multibody mechanical system embodying the invention will be obvious for those skilled in the art. It is to be understood that although preferred embodiments, specific constructions and configurations, have been discussed herein for devices according to the present invention, various changes or modifications in form and detail may be made without departing from the scope and spirit of this invention.

1-20. (canceled)

21. A method for determining, over a number of time steps δt, motion of a constrained mechanical system comprising multiple bodies, said constrained mechanical system being constrained by a set of constraints defining a constraint subspace, the constrained mechanical system furthermore comprising at least one fixed joint and at least one further joint constrained by at least one constraint of the set of constraints, the method comprising
obtaining a set of Hamiltonian equations of motion formulated in recursive form for said constrained mechanical system, and
for each of said number of time steps δt,
recursively calculating at least position related information of said multiple bodies of said constrained mechanical system based on said set of Hamiltonian equations of motion,
wherein
said obtaining a set of Hamiltonian equations of motion formulated in recursive form comprises
for each K^{th} body of the constrained mechanical system,
determining a quantity related to a constrained articulated momentum vector of said K^{th} body, said constrained articulated momentum vector of said K^{th} body being the sum of a momentum vector of the K^{th} body of the system and the projected constrained articulated momentum vectors of adjacent bodies that are located closer to said at least one further joint than said K^{th} body, said projected constrained articulated momentum vectors being projected on said constraint subspace and referring to a local reference frame of the K^{th} body,
using said quantities related to said constrained articulated momentum vectors for obtaining said set of Hamiltonian equations of motion for said constrained mechanical system.

22. A method for determining, over a number of time steps δt, motion of a constrained mechanical system comprising multiple bodies, said constrained mechanical system being constrained by a set of constraints defining a constraint subspace, the constrained mechanical system furthermore comprising at least one fixed joint and at least one further joint constrained by at least one constraint of the set of constraints, the method comprising
obtaining a set of Hamiltonian equations of motion formulated in recursive form for said constrained mechanical system, and
for each of said number of time steps δt,
recursively calculating at least position related information of said multiple bodies of said constrained mechanical system based on said set of Hamiltonian equations of motion,
wherein
said obtaining a set of Hamiltonian equations of motion formulated in recursive form comprises
for each K^{th} body of the constrained mechanical system, the K^{th} body comprising a set of dependent bodies of K,
determining a quantity related to a constrained articulated momentum vector of said K^{th} body, said constrained articulated momentum vector of said K^{th} body being the sum of the articulated momentum vector of body K and a linear function of all the dependent canonical momenta conjugate to the dependent bodies
using said quantities related to said constrained articulated momentum vectors for obtaining said set of Hamiltonian equations of motion for said constrained mechanical system.

23. A method for determining motion according to claim 21, wherein said set of Hamiltonian equations of motion comprises, for generalized coordinates q, conjugated canonical momenta p, and time t,
expressions for the time derivatives of the generalized coordinates q and of the conjugated canonical momenta p
\dot{q}=F(q,p,t)
\dot{p}=G(q,p,t)
and wherein using said quantities related to said constrained articulated momentum vectors for obtaining a set of Hamiltonian equations of motion for said constrained mechanical system comprises deriving an expression for the time derivatives of the conjugated canonical momenta p
\dot{p}=G(q,p,t)
from the quantities related to said constrained articulated momentum vectors.

24. A method for determining motion according to claim 21, wherein said recursively calculating comprises
backward recursively calculating a constrained articulated mass matrix for the constrained mechanical system,
forward recursively calculating the time derivatives of the generalised co-ordinates q,
backward recursively calculating constrained accumulated force vectors, each constrained accumulated force vector expressing the accumulated force on the body under study, and
determining the time derivatives of the conjugated canonical momenta p.

25. A method for determining motion according to claim 24, the method furthermore comprising
forward recursively calculating in order to determine a further constraint matrix and
during said first backward recursively calculating,
reversing the recursion direction when a last dependent body is met.

26. A method for determining motion according to claim 21 wherein said obtaining a set of Hamiltonian equations of motion for said constrained mechanical system comprises inputting a set of Hamiltonian equations of motion from a data source.

27. A method for determining motion according to claim 21, wherein said motion comprises the forward dynamics of said constrained mechanical system.

28. A method for determining motion according to claim 21, wherein said method comprises studying an impact on said constrained mechanical system based on a sudden change in said generalized coordinates q or said conjugated canonical momenta p.

29. A method for determining motion according to claim 21, wherein said method comprises studying multiple bodies in contact with each other.

30. A method for determining motion according to claim 21, wherein said multiple bodies are rigid bodies, each body connected to at least another body of said multiple bodies with a joint.

31. A method for determining motion according to claim 21, wherein said determining motion is applied in any of virtual prototyping, virtual reality or computer animation.

32. A method according to claim 23, wherein said determining a quantity related to a constrained articulated momentum vector of said K^{th} body comprises determining a constrained articulated momentum vector P_{K}^{c} given by
$${P}_{K}^{c} = {P}_{K} + {\sum }_{j ∈ AOB} {}_{}^{K}{T}{}_{j}^{F} {C}_{j}^{T} {P}_{j}^{c}$$
wherein P_{K} is said momentum vector of the K^{th} body, the set AOB comprises all adjacent outboard bodies, i.e. all bodies adjacent to body K and being closer to the at least one further joint than body K, Cⱼ^{T}Pⱼ^{c} is said projection of the constrained momentum vector of an adjacent body closer to the at least one further joint and ^{K}Tⱼ^{F} is a transformation matrix transforming the projection of the constrained momentum vector Cⱼ^{T}Pⱼ^{c} referred to a local reference frame of a j^{th} body to the projection of the constrained momentum vector Cⱼ^{T}Pⱼ^{c} referred to said local reference frame of said K^{th} body.

33. A method according to claim 21, wherein obtaining a set of Hamiltonian equations of motion comprises using a principle of virtual power.

34. A computing device for computing the motion over a number of time steps δt of a constrained mechanical system comprising multiple bodies, said constrained mechanical system being constrained by a set of constraints defining a constraint subspace, the constrained mechanical system furthermore comprising at least one fixed joint and at least one further joint constrained by at least one constraint of the set of constraints, the computing device comprising
means for obtaining data relating to a set of Hamiltonian equations of motion formulated in recursive form for said constrained mechanical system, and
means for recursively computing, for each of said number of time steps δt, at least position related information of said multiple bodies of said constrained mechanical system based on said set of Hamiltonian equations of motion, wherein said means for obtaining data relating to a set of Hamiltonian equations formulated in recursive form comprises
a means for, for each K^{th} body of the constrained mechanical system, determining a quantity related to a constrained articulated momentum vector of said K^{th} body, said constrained articulated momentum vector of said K^{th} body being the sum of a momentum vector of the K^{th} body of the system and the projected constrained articulated momentum vectors of adjacent bodies that are located closer to said at least one further joint than said K^{th} body, said projected constrained articulated momentum vectors being projected on said constraint subspace and referring to a local reference frame of the K^{th} body, and,
a means for using said quantities related to said constrained articulated momentum vectors for obtaining a set of Hamiltonian equations of motion for said constrained mechanical system.

35. A computing device for computing the motion over a number of time steps δt of a constrained mechanical system comprising multiple bodies, said constrained mechanical system being constrained by a set of constraints defining a constraint subspace, the constrained mechanical system furthermore comprising at least one fixed joint and at least one further joint constrained by at least one constraint of the set of constraints, the computing device comprising
means for obtaining data relating to a set of Hamiltonian equations of motion formulated in recursive form for said constrained mechanical system, and
means for recursively computing, for each of said number of time steps δt, at least position related information of said multiple bodies of said constrained mechanical system based on said set of Hamiltonian equations of motion, wherein said means for obtaining data relating to a set of Hamiltonian equations formulated in recursive form comprises
a means for, for each K^{th} body of the constrained mechanical system, the K^{th} body comprising a set of dependent bodies of K, determining a quantity related to a constrained articulated momentum vector of said K^{th} body, said constrained articulated momentum vector of said K^{th} body being the sum of the articulated momentum vector of body K and a linear function of all the dependent canonical momenta conjugate to the dependent bodies, and
using said quantities related to said constrained articulated momentum vectors for obtaining a set of Hamiltonian equations of motion for said constrained mechanical system.

36. A computer program product to be utilized with a computer system for studying over a number of time steps δt the motion of a constrained mechanical system comprising multiple bodies, the computer program product being adapted for performing a method according to claim 21.

37. A machine readable data storage device storing the computer program product as claimed in claim 36.

38. Transmission of a computer program product according to claim 36 over a local area telecommunications network.

39. A method for determining motion according to claim 22, wherein said set of Hamiltonian equations of motion comprises, for generalized coordinates q, conjugated canonical momenta p, and time t,
expressions for the time derivatives of the generalized coordinates q and of the conjugated canonical momenta p
\dot{q}=F(q,p,t)
\dot{p}=G(q,p,t)
and wherein using said quantities related to said constrained articulated momentum vectors for obtaining a set of Hamiltonian equations of motion for said constrained mechanical system comprises deriving an expression for the time derivatives of the conjugated canonical momenta p
\dot{p}=G(q,p,t)
from the quantities related to said constrained articulated momentum vectors.

40. A method for determining motion according to claim 22, wherein said recursively calculating comprises
backward recursively calculating a constrained articulated mass matrix for the constrained mechanical system,
forward recursively calculating the time derivatives of the generalised co-ordinates q,
backward recursively calculating constrained accumulated force vectors, each constrained accumulated force vector expressing the accumulated force on the body under study, and
determining the time derivatives of the conjugated canonical momenta p.

41. A method for determining motion according to claim 22, the method furthermore comprising
forward recursively calculating in order to determine a further constraint matrix and
during said first backward recursively calculating,
reversing the recursion direction when a last dependent body is met.

42. A method for determining motion according to claim 22 wherein said obtaining a set of Hamiltonian equations of motion for said constrained mechanical system comprises inputting a set of Hamiltonian equations of motion from a data source.

43. A method for determining motion according to claim 22, wherein said motion comprises the forward dynamics of said constrained mechanical system.

44. A method for determining motion according to claim 22, wherein said method comprises studying an impact on said constrained mechanical system based on a sudden change in said generalized coordinates q or said conjugated canonical momenta p.

45. A method for determining motion according to claim 22, wherein said method comprises studying multiple bodies in contact with each other.

46. A method for determining motion according to claim 22, wherein said multiple bodies are rigid bodies, each body connected to at least another body of said multiple bodies with a joint.

47. A method for determining motion according to claim 22, wherein said determining motion is applied in any of virtual prototyping, virtual reality or computer animation.

48. A method according to claim 41, wherein said determining a quantity related to a constrained articulated momentum vector of said K^{th} body comprises determining a constrained articulated momentum vector P_{K}^{c} given by
$${P}_{K}^{c} = {P}_{K}^{*} + {\sum }_{i ∈ dep ( K )} {}_{}^{K}{T}{}_{i}^{F} {C}_{{q}_{i}}^{*} {E}_{i}^{T} {P}_{i}^{*}$$
wherein
P*_{K} is the articulated momentum vector of articulated body K,
the set dep(K) comprises all bodies dependent on body K and
Eᵢ^{T}P*ᵢ is the dependent canonical momenta conjugate to dependent body i,
^{K}Tᵢ^{F} is a transformation matrix transforming a description of a force or momentum vector with respect to a reference frame associated to body i to a description of the same force or momentum vector with respect to a reference frame associated to body K, and C*_{q}_{ᵢ} is a function of the matrix C representing the constraints of the multibody system.

49. A method according to claim 41, wherein obtaining a set of Hamiltonian equations of motion comprises arbitrary selecting a number of dependent bodies in said constrained mechanical system.

50. A method according to claim 22, wherein obtaining a set of Hamiltonian equations of motion comprises using a principle of virtual power.

51. A computer program product to be utilized with a computer system for studying over a number of time steps δt the motion of a constrained mechanical system comprising multiple bodies, the computer program product being adapted for performing a method according to claim 22.

52. A machine readable data storage device storing the computer program product as claimed in claim 33.

53. Transmission of a computer program product according to claim 33 over a local area telecommunications network.
